(19) United States
(12) Patent Application Publication
(10) Pub. No.: US 2025/0189435 A1
(43) Pub. Date: Jun. 12, 2025

(54) ACOUSTIC RESONANCE-BASED METROLOGY OF SAMPLES

(71) Applicant: Applied Materials Israel Ltd., Rehovot (IL)

(72) Inventors: Ori Golani, Kibbutz Shoval (IL); Ido Almog, Rehovot (IL); Yariv Simovitch, Rehovot (IL)

(73) Assignee: Applied Materials Israel Ltd., Rehovot (IL)

(21) Appl. No.: 18/536,116

(22) Filed: Dec. 11, 2023

(51) Int. Cl. G01N 21/17

(52) U.S. Cl. CPC G01N 21/1702; G01N 2021/1706; G01N 2201/06113

(57) ABSTRACT

Disclosed herein is a computerized system for metrology of structures. The system includes an optical setup and a computational module. The optical setup is configured to: (i) project on a profiled structure at least one optical pump beam, which is configured to be absorbed by the profiled structure, so as to induce vibrations of the profiled structure and a corresponding change in a reflection coefficient of the profiled structure; (ii) while the profiled structure is vibrating, project on the profiled structure at least one probe beam; and (iii) sense at least one light beam, returned from the profiled structure, thereby obtaining at least one measured signal. The computational module is configured to process the at least one measured signal to determine one or more structural parameters of the profiled structure.

### TECHNICAL FIELD

The present disclosure relates generally to metrology of samples.

### BACKGROUND OF THE INVENTION

With the shrinking of design rules, process control of the production of semiconductor samples grows ever more complex as metrology of increasingly smaller structures is required. State-of-the-art non-destructive techniques for structural metrology of semiconductor samples primarily rely on scanning electron microscopy, optical critical dimension (OCD) scatterometry, and/or small angle X-ray scattering (SAXS). There remains an unmet need in the art for non-destructive techniques for metrology of semiconductor samples, which afford greater accuracy.

### BRIEF SUMMARY OF THE INVENTION

Aspects of the disclosure, according to some embodiments thereof, relate to metrology of samples. More specifically, but not exclusively, aspects of the disclosure, according to some embodiments thereof, relate to photo-acoustic metrology of semiconductor structures. Even more specifically, but not exclusively, aspects of the disclosure, according to some embodiments thereof, relate to photo-acoustic metrology of semiconductor structures, which is based on excitation of acoustic resonances.

Thus, according to an aspect of some embodiments, there is provided a computerized system for metrology of structures. The system includes an optical setup and a processing circuitry. The optical setup is configured to:
Project on a profiled structure at least one pump beam. The at least one pump beam is configured to be absorbed by the profiled structure, so as to induce vibrations throughout the profiled structure, and thereby cause a corresponding change in a reflection coefficient of the profiled structure.
while the profiled structure is vibrating, project on the profiled structure at least one probe beam.
Sense at least one light beam returned from the profiled structure, thereby obtaining at least one measured signal.

The processing circuitry is configured to process the at least one measured signal to determine (values of) one or more structural parameters of the profiled structure.

According to some embodiments of the system, the at least one pump beam is configured such that the induced vibrations include one or more resonant vibrations corresponding to excited resonant modes.

According to some embodiments of the system, the processing circuitry is configured to process the at least one measured signal to identify frequencies of each of the one or more resonant vibrations, and, based at least thereon, determine the one or more structural parameters of the profiled structure.

According to some embodiments of the system, the processing (which the processing circuitry is configured to perform) includes searching for peaks and/or dips in each of the at least one measured signal, and/or in each of at least one processed signal derived therefrom, respectively, and, for each detected peak/dip, determining whether the peak/dip corresponds to a resonant vibration, and, if so, localizing the peak/dip and, optionally, determining the intensity peak/dip.

According to some embodiments of the system, the profiled structure is characterized by a geometry, which varies about (i.e., substantially) periodically along one direction.

According to some embodiments of the system, wherein the processing circuitry is configured to execute an algorithm, which has been trained to correlate between measured signals, or processed signals derived therefrom, and structural parameters obtained from ground truth data of structures of a same intended design as the profiled structure.

According to some embodiments of the system, wherein the algorithm is a neural network.

According to some embodiments of the system, wherein the optical setup includes light generating equipment and at least one light sensor. The light generating equipment is configured to generate the at least one pump beam and the at least one probe beam. The at least one light sensor is configured to measure an intensity and/or a spectrum of the at least one returned light beam, respectively.

According to some embodiments of the system, the at least one sensor is configured to sense returned light at each of a plurality of optical modes specified by one or more wavelength, return angle, and polarization.

According to some embodiments of the system, the at least one sensor includes a plurality of light sensors and/or a light sensor array.

According to some embodiments of the system, the at least one light sensor is configured to sense light returned from different locations on the profiled structure.

According to some embodiments of the system, the light generating equipment is additionally configured to sense backscattered light.

According to some embodiments of the system, the optical setup further includes a controller configured to command and coordinate operation of components of the optical setup.

According to some embodiments of the system, the light generating equipment further includes an optical modulator, which is configured to amplitude-modulate the at least one pump beam. The processing circuitry includes one or more processors and a lock-in amplifier. The lock-in amplifier is configured to use a modulation frequency of the at least one pump beam to demodulate the measured signal and extract a transient component of thereof, and thereby isolate a contribution to the transient component of a reflected portion of the probe beam due to the induced vibrations. The one or more processors are configured to process the isolated contribution to the transient component to determine one or more structural parameters of the profiled structure.

According to some embodiments of the system, a modulation frequency of the at least one pump beam is between about 10 kHz and about 10 MHz.

According to some embodiments of the system, each of the at least one pump beam is a laser beam and/or each of the at least one probe beam is a laser beam.

According to some embodiments of the system, the at least one pump beam includes two or more pump beams, which differ from one another in one or more of wavelength, incidence angle, polarization, and numerical aperture.

According to some embodiments of the system, the at least one pump beam includes two or more pump beams configured to produce a static, a time-dependent, or a travelling illumination pattern on the profiled structure.

According to some embodiments of the system, the two or more pump beams are configured to excite one or more surface acoustic modes at resonance with the structure.

According to some embodiments of the system, each of the at least one pump beam is pulsed so as to include a plurality of consecutively generated pump pulses.

According to some embodiments of the system, a duration(s) of each of the pump pulses is shorter by at least about an order of magnitude than a duration of a relaxation interval of the induced vibrations.

According to some embodiments of the system, the duration(s) of each pump pulse is between about 20 fs and about 50 ps.

According to some embodiments of the system, the light generating equipment further includes a continuous-wave (CW) laser generator configured to prepare the probe beam.

According to some embodiments of the system, the at least one light sensor includes a fast optical detector(s).

According to some embodiments of the system, a bandwidth of the fast optical detector(s) is at least about twice greater than a maximum frequency of the induced resonant vibrations.

According to some embodiments of the system, the processing circuitry is configured to apply a Fourier transform algorithm to each of the at least one measured signal, and/or to each of an at least one initially processed signal obtained from the at least one measured signal, respectively.

According to some embodiments of the system, the at least one light sensor includes an ultra-high-resolution spectrometer.

According to some embodiments of the system, the at least one probe beam includes two or more probe beams, which differ from one another in one or more of wavelength, incidence angle, polarization, and numerical aperture.

According to some embodiments of the system, each of the at least one probe beam is pulsed, so as to include a plurality of consecutively generated probe pulses.

According to some embodiments of the system, a pulse rate of the probe pulses is equal to a pulse rate of the pump pulses.

According to some embodiments of the system, the light generating equipment includes a variable delay-line configured to allow controllably setting a time-delay of each of the probe pulses relative to the pump pulses, respectively.

According to some embodiments of the system, the light generating equipment includes one or more CW laser generators configured to prepare the at least one pump beam and the at least one probe beam.

According to some embodiments of the system, the light generating equipment is configured to sweep an amplitude-modulation frequency of the at least one pump beam across one or more modulation frequency ranges.

According to some embodiments of the system, a lower bound on the one or more modulation frequency ranges is greater than about 0.2 GHz and an upper bound on the one or more modulation frequency ranges is smaller than about 500 GHz.

According to some embodiments of the system, the optical setup further includes a controller and the one or more CW laser generators include two frequency-locked CW laser sources used in preparing the at least one pump beam. The controller is configured to vary a frequency difference between the two frequency-locked CW laser sources, thereby implementing the frequency sweep.

According to some embodiments of the system, the profiled structure includes one or more trenches, depressions, and/or grooves.

According to some embodiments of the system, the profiled structure includes a semiconductor material.

According to some embodiments of the system, the profiled structure is constructed as part of a manufacturing processes of semiconductor devices and/or components of semiconductor devices.

According to some embodiments of the system, the profiled structure is an assist structure, which is constructed as part of a manufacturing processes of semiconductor devices and/or components of semiconductor devices.

According to some embodiments of the system, the optical setup further includes an optical filter configured to block at least a scattered and/or specularly reflected portion of the pump beam.

According to some embodiments of the system, the optical setup further includes an objective lens configured to focus the at least one pump beam and the at least one probe beam on the profiled structure.

According to some embodiments of the system, the light generating equipment includes one or more polarization modules, configured to allow controllably setting polarizations of the at least one pump beam and/or the at least one probe beam.

According to some embodiments of the system, the processing circuitry is configured to take into account a nominal design of the profiled structure in determining the one or more structural parameters thereof.

According to an aspect of some embodiments, there is provided a method for metrology of structures. The method includes operations of:
Projecting on a profiled structure at least one pump beam, which is configured to be absorbed by the profiled structure, so as to induce vibrations throughout the profiled structure, which cause a corresponding change in a reflection coefficient of the profiled structure.
While the profiled structure is vibrating, projecting on the profiled structure at least one probe beam.
Sensing at least one light beam returned from the profiled structure, thereby obtaining at least one measured signal.
Processing the at least one measured signal to determine (values of) one or more structural parameters of the profiled structure.

According to some embodiments of the method, the at least one pump beam is configured such that the induced vibrations include one or more resonant vibrations corresponding to excited resonant modes.

According to some embodiments of the method, the operation of processing at least one measured signal includes identifying frequencies of each of the one or more resonant vibrations, and, based at least thereon, determining the one or more structural parameters of the profiled structure.

According to some embodiments of the method, the identifying of the frequencies includes searching for peaks and/or dips in each of the at least one measured signal, and/or in each of at least one processed signal derived therefrom, respectively, and, for each detected peak/dip, determining whether the peak/dip corresponds to a resonant vibration, and, if so, localizing the peak/dip and, optionally, determining the intensity of the peak/dip.

According to some embodiments of the method, the profiled structure is characterized by a geometry, which varies about (substantially) periodically along one direction.

According to some embodiments of the method, the operation of processing the at least one measured signal includes executing an algorithm, which has been trained to correlate between measured signals, or processed signals derived therefrom, and structural parameters obtained from ground truth data of structures of a same intended design as the profiled structure.

According to some embodiments of the method, the operation of sensing the at least one light beam includes measuring an intensity and/or a spectrum of the at least one returned light beam.

According to some embodiments of the method, the at least one pump beam is amplitude-modulated. The operation of processing the at least one measured signal includes: (i) using a modulation frequency of the at least one pump beam to demodulate the measured signal and extract a transient component thereof, thereby isolating a contribution to the transient component of a reflected portion of the probe beam due to the induced vibrations, and (ii) processing the isolated contribution to the transient component to determine the one or more structural parameters of the profiled structure.

According to some embodiments of the method, the modulation frequency is between about 10 kHz and about 10 MHz.

According to some embodiments of the method, in the operation of the sensing the at least one light beam, two or more light beams, returned at two or more return angles, respectively, are sensed.

According to some embodiments of the method, in the operation of the sensing the at least one light beam, backscattered light is additionally sensed.

According to some embodiments of the method, each of the at least one pump beam is a laser beam and/or each of the at least one probe beam is a laser beam.

According to some embodiments of the method, the at least one pump beam includes two or more pump beams, which differ from one another in one or more of wavelength, incidence angle, polarization, and numerical aperture.

According to some embodiments of the method, the at least one pump beam includes two or more pump beams configured to produce a static, a time-dependent, or a travelling illumination pattern on the profiled structure.

According to some embodiments of the method, the two or more pump beams are configured to excite one or more surface acoustic modes at resonance with the profiled structure.

According to some embodiments of the method, each of the at least one pump beam is pulsed so as to include a plurality of consecutively generated pump pulses.

According to some embodiments of the method, a duration(s) of each of the pump pulses is shorter by at least about one order of magnitude than a duration of a relaxation interval of the induced vibrations.

According to some embodiments of the method, the duration(s) of each pump pulse is between about 20 fs and about 50 ps.

According to some embodiments of the method, the probe beam is continuous-wave.

According to some embodiments of the method, in the operation of sensing the at least one returned light beam, a fast optical detector(s) is used.

According to some embodiments of the method, a bandwidth of the fast optical detector(s) is at least about twice greater than a maximum frequency of the induced resonant vibrations.

According to some embodiments of the method, in the operation of processing the at least one measured signal, a Fourier transform algorithm is applied to each of the at least one measured signal, and/or to each of an at least one initially processed signal obtained from the at least one measured signal, respectively.

According to some embodiments of the method, in the operation of sensing the at least one returned light beam, an ultra-high-resolution spectrometer is used.

According to some embodiments of the method, the at least one probe beam includes two or more probe beams, which differ from one another in one or more of wavelength, incidence angle, polarization, and numerical aperture.

According to some embodiments of the method, each of the at least one probe beam is pulsed so as to include a plurality of consecutively generated probe pulses.

According to some embodiments of the method, a pulse rate of the probe pulses is equal to a pulse rate of the pump pulses.

According to some embodiments of the method, a variable delay-line is used to controllably set a time-delay of each of the probe pulses relative to the pump pulses, respectively.

According to some embodiments of the method, in the operations of projecting on the profiled structure the at least one pump beam and the at least one probe beam, one or more CW laser generators are used to prepare the at least one pump beam and the at least one probe beam.

According to some embodiments of the method, the one or more CW laser generators include a first CW laser generator configured to prepare the at least one pump beam and a second CW laser generator configured to prepare the at least one probe beam.

According to some embodiments of the method, the at least one pump beam is amplitude-modulated. In the operation of projecting on the profiled structure the at least one pump beam, a modulation frequency of the at least one pump beam is swept across one or more frequency ranges.

According to some embodiments of the method, a lower bound on the one or more frequency ranges is greater than about 0.2 GHz and an upper bound on the one or more frequency ranges is smaller than about 500 GHz.

According to some embodiments of the method, in the operation of projecting on the profiled structure the at least one pump beam two frequency-locked CW laser sources are used to prepare the at least one pump beam. The operation of projecting on the profiled structure the at least one pump beam further comprises varying a frequency difference between the two frequency-locked CW laser sources, thereby implementing the frequency sweep.

According to some embodiments of the method, the algorithm is a neural network.

According to some embodiments of the method, the profiled structure includes one or more trenches, depressions, and/or grooves.

According to some embodiments of the method, the profiled structure includes a semiconductor material.

According to some embodiments of the method, the profiled structure is constructed as part of a manufacturing processes of semiconductor devices and/or components of semiconductor devices.

According to some embodiments of the method, the profiled structure is an assist structure, which is constructed as part of a manufacturing processes of semiconductor devices and/or components of semiconductor devices.

According to some embodiments of the method, in the operation of sensing the at least one light beam, an optical filter is utilized block at least a scattered and/or specularly reflected portion of the at least one pump beam.

According to some embodiments of the method, in the operations of projecting on the profiled structure the at least pump beam and the at least one probe beam, an objective lens is utilized to focus the at least one pump beam and the at least one probe beam on the profiled structure.

According to some embodiments of the method, the at least one pump beam and/or the at least one probe beam are polarized.

According to some embodiments of the method, in the operation of processing the at least one measured signal a nominal design of the profiled structure is taken into account in determining the one or more structural parameters of the profiled structure.

According to an aspect of some embodiments, there is provided a non-transitory computer-readable storage medium. The storage medium stores instructions that cause a computerized system for metrology of structures, such as the above-described system, to implement the above-described method with respect to a profiled structure.

According to an aspect of some embodiments, there is provided a non-transitory computer-readable storage medium. The storage medium stores instructions that cause a processing circuitry to process the at least one measured signal to determine (values of) one or more structural parameters of a profiled structure. The at least one measured signal is obtained by:
Projecting on the profiled structure at least one pump beam, which is configured to be absorbed by the profiled structure, so as to induce vibrations throughout the profiled structure, which cause a corresponding change in a reflection coefficient of the profiled structure.
While the profiled structure is vibrating, projecting on the profiled structure at least one probe beam.
Sensing at least one light beam returned from the profiled structure, thereby obtaining the at least one measured signal.

According to some embodiments of the storage medium, the at least one pump beam is configured such that the induced vibrations include one or more resonant vibrations corresponding to excited resonant modes.

According to some embodiments of the storage medium, the processing circuitry is configured to process the at least one measured signal so as to identify frequencies of each of the one or more resonant vibrations, and, based at least thereon, determine the one or more structural parameters of the profiled structure.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g., electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1A presents a flowchart of a computer implemented method for profiling of structures, according to some embodiments;

FIG. 1B presents a flowchart of a measurement data processing operation of the method of FIG. 1A, according to some specific embodiments thereof,

FIG. 2 presents a perspective view of a sample including a structure amenable to profiling using to the method of FIG. 1A, according to some embodiments thereof,

FIGS. 3A to 3C present stages in the profiling of structure of FIG. 2 using the method of FIG. 1A, according to some embodiments thereof,

FIGS. 4A to 4D schematically depict vibrations in a structure undergoing profiling in accordance with the method of FIG. 1A, according to some embodiments thereof,

FIGS. 5A to 5D schematically depict four types of vibrations, respectively, which may be induced in a structure when subject to profiling according to some embodiments of the method of FIG. 1A;

FIG. 6 presents a block diagram of a computerized system for profiling of structures characterized by periodic or substantially periodic geometry along one of their dimensions, according to some embodiments;

FIGS. 7 to 9A schematically depicts three computerized systems, respectively, which correspond to specific embodiments of the computerized system of FIG. 6;

FIG. 9B schematically depicts light generation equipment, which corresponds to specific embodiments of the light generation equipment of the computerized system of FIG. 6;

FIGS. 10 to 12 present three flowcharts of three computer implemented methods for profiling of structures, which correspond to specific embodiments of the method of FIG. 1A; and

FIGS. 13A and 13B present results of computer simulations indicative of the feasibility of the disclosed methods.

### DETAILED DESCRIPTION OF THE INVENTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

State-of-the-art non-destructive techniques for metrology of semiconductor samples primarily rely on scanning electron microscopy, optical critical dimension (OCD) scatterometry, or small angle X-ray scattering (SAXS). Scanning electron microscopy allows for high-resolution (two-dimensional) imaging of top surfaces of samples (e.g., semiconductor samples) but is poor at detecting or distinguishing below-surface structural features and deep lying parts. In contrast, OCD scatterometry is typically sensitive to buried structural features provided that the sample is optically transparent, but is often incapable of characterizing buried structures. If two or more parameters of a buried structure are simultaneously changed, OCD might not be able to distinguish between them. For example, so long as the optical path length of a traversing optical beam remains unchanged (e.g., under simultaneous change of the dimensions and the refractive index of a buried structure), the change will not be detected.

The present application discloses a novel non-destructive approach to three-dimensional metrology. By inducing a temporally-dependent change in the reflection coefficient of a structure (e.g., a semiconductor structure) through the excitation of mechanical (acoustic) vibrations therein, and reflecting a probe beam off the structure to obtain a measured signal indicative of the time-dependence of the change in the reflection coefficient, three-dimensional structural information regarding the structure may be extracted. More specifically, the disclosed approach makes use of the fact that acoustic resonances are typically highly sensitive to (structural) variations in dimensions on the nanometric scale (as opposed to optical resonances, which are usually not formed in structures smaller than 100 nm). Consequently, small variations in dimensions can be discerned through the excitation of acoustic resonances. As a further advantage, the disclosed approach is not limited to optically transparent structures.

As used herein, according to some embodiments, the term “profiling”, in the context of process control in the fabrication of a patterned wafer, refers to measurement and analysis-based estimation of average (values) of one or more representative geometrical features of a structure (i.e., the structure being profiled), which the wafer includes and which nominally exhibits periodicity along at least one direction.

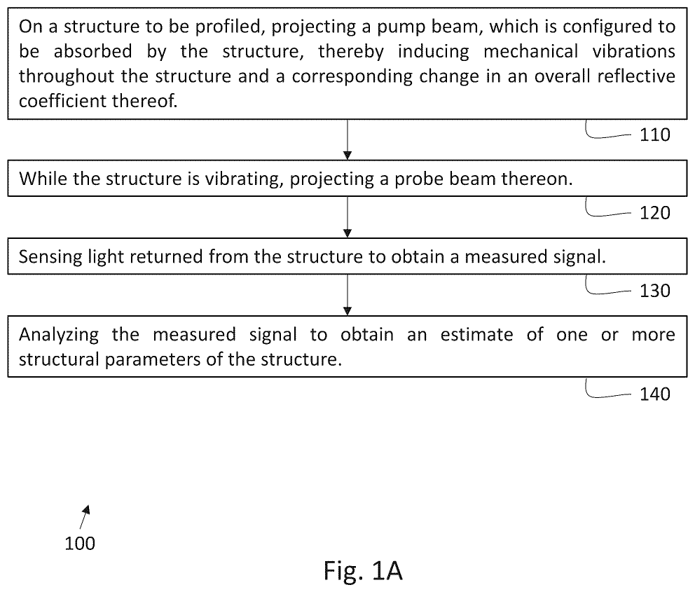

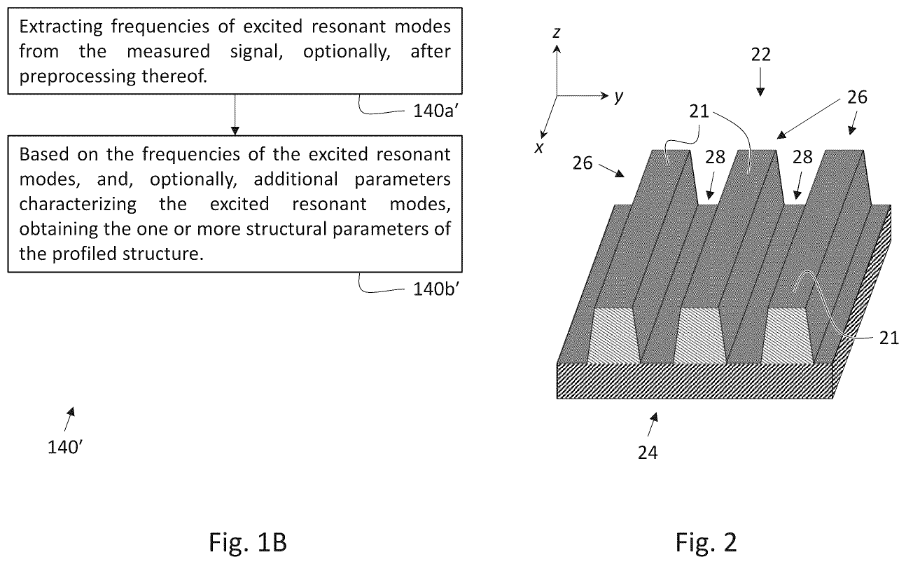

FIG. 1 presents a flowchart of a method 100 for metrology of structures (e.g., semiconductor structures), according to some embodiments. Method 100 includes:
An operation 110, wherein at least one optical pump beam (for short, referred to as “the pump beam”) is projected on a structure, which is to be profiled (referred to as “the profiled structure”). The pump beam is configured to be absorbed by the profiled structure, thereby inducing mechanical (acoustic) vibrations throughout the profiled structure and a corresponding change in the reflection coefficient of the profiled structure.
An operation 120, implemented while the profiled structure is vibrating, wherein an optical probe beam (for short, referred to as “the probe beam”) is projected on the profiled structure.
An operation 130, wherein a measured signal is obtained by measuring an intensity of a light beam returned from the profiled structure.
An operation 140, wherein the measured signal is processed to determine (values of) one or more structural parameters of the profiled structure (i.e., at least one parameter characterizing the geometry and/or material composition of the profiled structure).

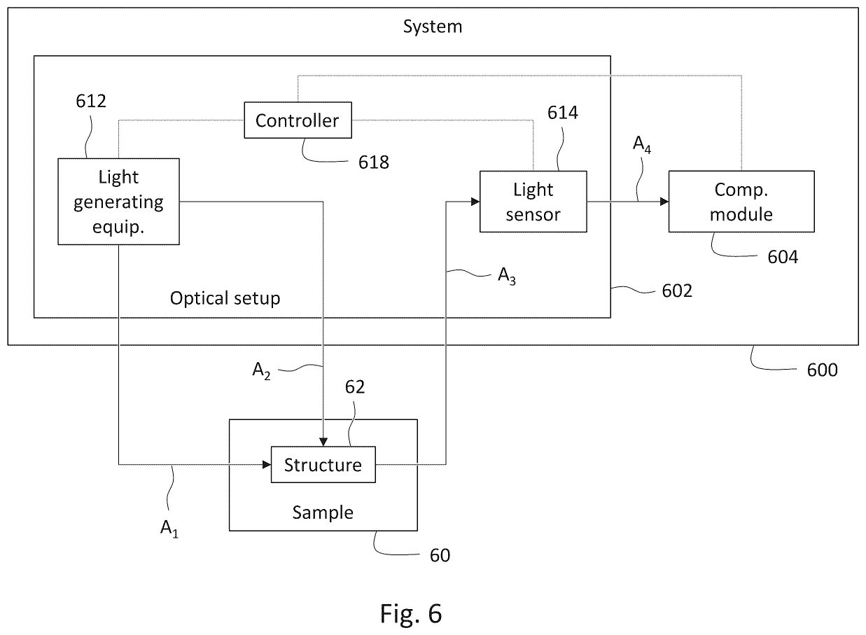

Method 100 may be implemented using any one of the systems described below in the description of FIGS. 6-9B, or systems similar thereto.

According to some embodiments, the profiled structure may be a semiconductor device (e.g., a patterned wafer). According to some embodiments, the profiled structure may be a semiconductor structure, or a metallic structure, included in the semiconductor device. According to some embodiments, the profiled structure may include one or more semiconductor materials, one or more metals, and/or one or more oxides. More generally, the scope of the disclosure will be understood to cover the profiling of substantially any microstructure, structure at the submicron scale, or nanostructure structure, which is produced in standard semiconductor manufacturing processes (e.g., patterning deposition, etching, and the like) whether including, or not including, a semiconductor material(s).

According to some embodiments, the profiled structure includes a plurality of nanostructures (e.g., fins) of a same intended design, which are distributed (e.g., nominally periodically) therein. The pump beam induces collective vibrations of the nanostructures, which are then “jointly probed” by impinging the probe beam and sensing the returned light beam. In such embodiments, method 100 will provide average values of structural parameters of the nanostructures rather than assigning specific values thereof to each of the nanostructures. As a non-limiting example, in embodiments wherein the nanostructures are fins, method 100 may be used to obtain the average height and average width of the fins, as well as the average separation between adjacent fins.

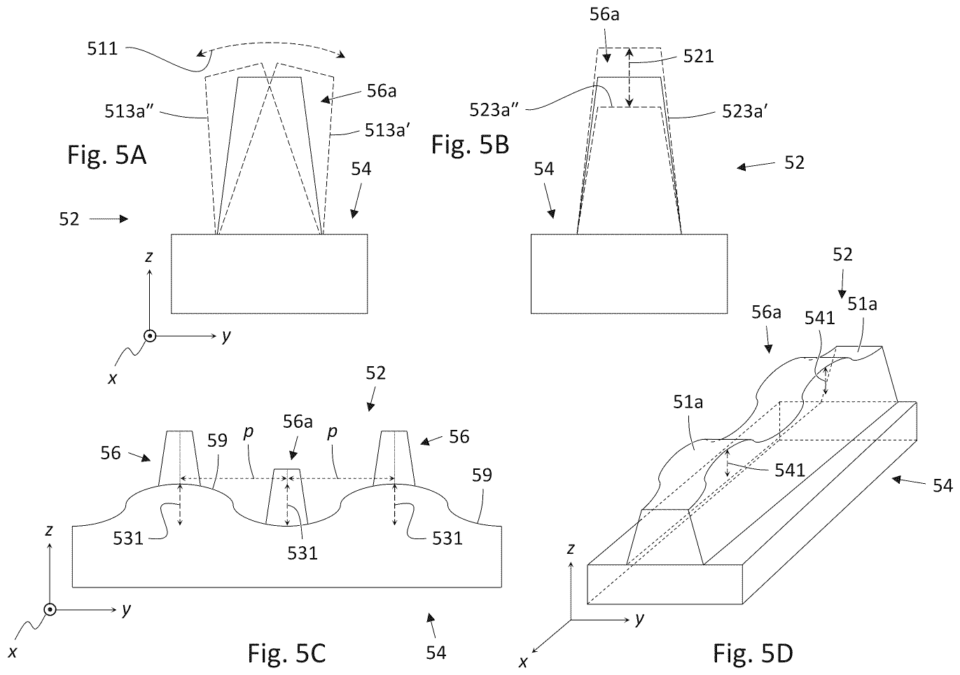

Parameters of the pump beam may be selected to ensure that in operation 110 the pump beam is absorbed by the sample and sufficiently heats the sample to induce large enough vibrations (on the order of 10-11 m, i.e., tens of picometers, when the profiled structure is nanometric or has at least one dimension on the order of 10 nm) of the profiled structure. Selectable parameters of the pump beam may include a wavelength thereof, and when the pump beam is amplitude-modulated, the modulation frequency (or modulation frequency range(s) when the modulation frequency is swept). Additional selectable parameters of the pump beam may include a duration, waveform (i.e., the temporal dependence of the shape of the wave), polarization, and/or incidence angle, and when the pump beam is pulsed, a duration(s) (i.e., width(s)) of the pump pulses, and/or time interval(s) between succeeding pump pulses. According to some embodiments, the induced vibrations may be dominated by, or at least include, vibrations resulting from the excitation of one or more acoustic resonances (i.e., acoustic resonant modes) of the profiled structure. It is noted that different acoustic resonant modes may give rise to vibrations along different axes, as detailed below in the description of FIGS. 5A-5D.

According to some embodiments, the pump beam is a laser beam.

According to some embodiments, the pump beam is a pulsed light beam (e.g., a pulsed laser beam). According to some such embodiments, each of the pulses has a duration of between about 100 fs (femtosecond) and about 10 ps (picosecond), between about 50 fs and about 20 ps, or between about 20 fs and about 100 ps. Each possibility corresponds to different embodiments. The wavelength of a pump pulse may be selected to ensure absorbance of the pump pulse by the profiled structure and the excitation mechanical vibrations across a continuous frequency range. That is, each pump pulse acts as an impulse excitation. According to some embodiments, the wavelength of a pump pulse may be selected to ensure the excitation of one or more resonant vibration modes. According to some embodiments, the pump beam may be additionally amplitude-modulated to facilitate isolating a contribution to the returned light beam, due to the induced vibrations, of a reflected portion of the probe beam. According to some embodiments, the modulation frequency may be on the order of 1 MHz.

According to some embodiments, the pump beam is a continuous-wave light beam (e.g., a continuous-wave laser beam), which is amplitude-modulated with the (amplitude) modulation frequency being swept. That is, the frequency of the envelope of a carrier (i.e., carrier wave) of the pump beam is swept. The wavelength of the carrier may be selected to ensure absorption by the profiled structure and heating thereof, while the frequency of the induced mechanical vibration is decided by the frequency of the envelope. More specifically, the modulation frequency may be swept over one or more continuous frequency ranges, thereby facilitating sequential excitation of mechanical vibration modes at different frequencies, in particular, the sequential excitation of different resonant vibration modes. According to some such embodiments, wherein the profiled structure is nanometric, the frequency range, over which the modulation frequency is swept, is contained, or substantially contained, in the 1 GHz to 100 GHz range, the 0.5 GHz to 200 GHz range, or the 0.2 GHz to 500 GHz range. Each possibility corresponds to separate embodiments.

According to some embodiments, the pump beam may be amplitude-modulated to facilitate isolating a contribution to the returned light beam, due to the induced vibrations, of a reflected portion of the probe beam. According to some such embodiments, the modulation frequency may be on the order of 1 MHz. Accordingly, in some such embodiments the pump beam is amplitude-modulated twice: once at a modulation frequency, which is swept over the e.g., 1 GHz to 100 GHz range, and once at a modulation frequency on the order of e.g., 1 MHz.

According to some embodiments, and as described in more detail below in the description of FIG. 6, in operation 110, a plurality of pump beams may be simultaneously projected on the profiled structure. At least some of the simultaneously projected pump beams may differ from one another in one or more of wavelength, incidences angles, azimuth angles, polarization, and numerical aperture. According to some embodiments, at least some of the pump beams may be configured to strike the profiled structure at different locations thereon. According to some embodiments, different pump beams may be amplitude-modulated by different modulation frequencies.

According to some embodiments, the probe beam is a laser beam.

According to some embodiments, the probe beam is a pulsed light beam (e.g., a pulsed laser beam). According to some such embodiments, each of the pulses has a duration of between about 100 fs and about 10 ps. According to some embodiments, a wavelength of the probe pulses may be in the deep ultraviolet (DUV) to the near infrared (NIR) range.

According to some alternative embodiments, the probe beam is a continuous-wave light beam (e.g., a continuous-wave laser beam). According to some such embodiments, the probe beam is narrow band laser. According to some embodiments, wherein the profiled structure is nanometric, the wavelength is contained in the DUV to NIR range. In particular, according to some embodiments, the wavelength of the probe beam may be selected to substantially maximize the relative change in the reflection coefficient of the profiled structure. According to some embodiments, the wavelength of the probe beam is adjustable.

According to some embodiments, and as described in more detail below in the description of FIG. 6, in operation 120, a plurality of probe beams may be simultaneously projected on the profiled structure. At least some of the simultaneously projected probe beams may differ from one another in one or more of wavelength, incidences angles, azimuth angles, polarization, numerical aperture, and striking location on structure.

According to some embodiments, the pump beam may have a first polarization state and the probe beam may have a second polarization state, which is orthogonal to the first polarization state.

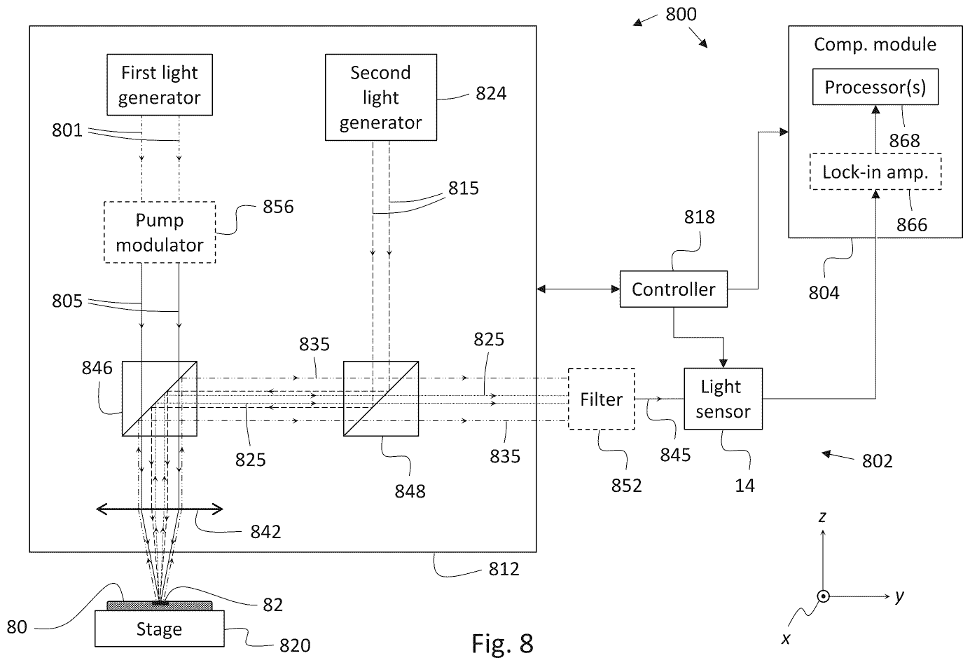

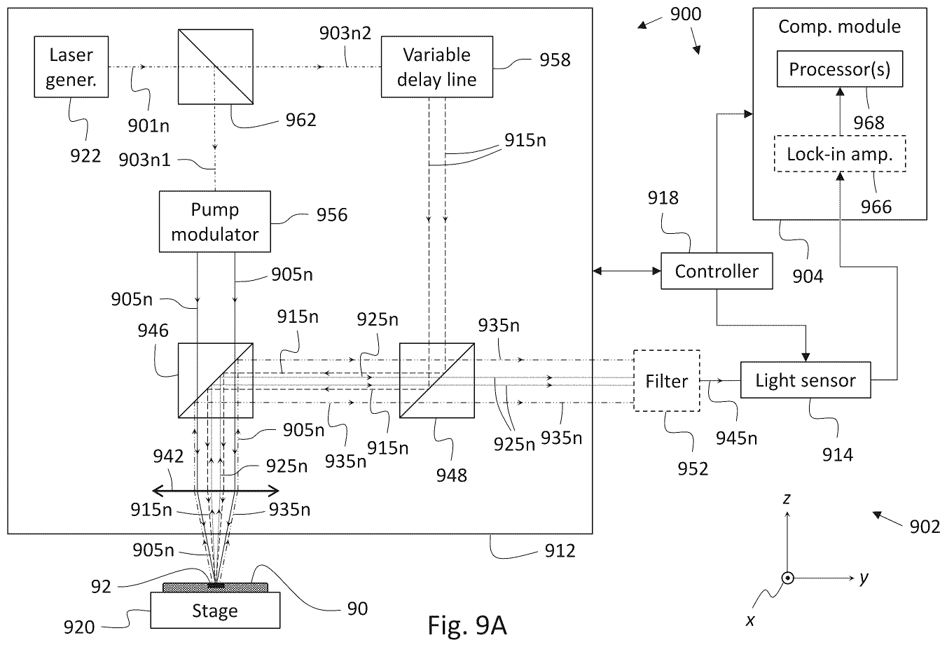

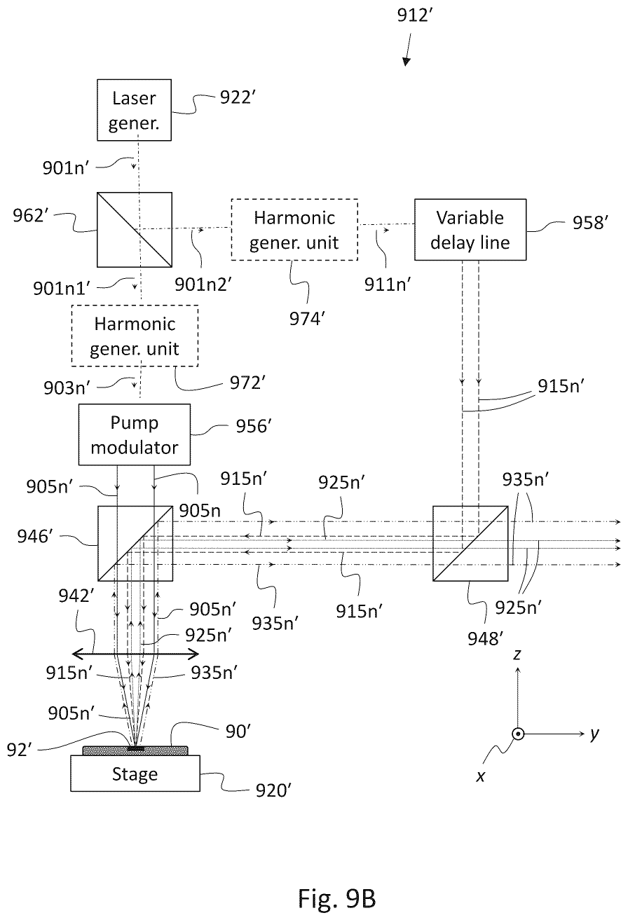

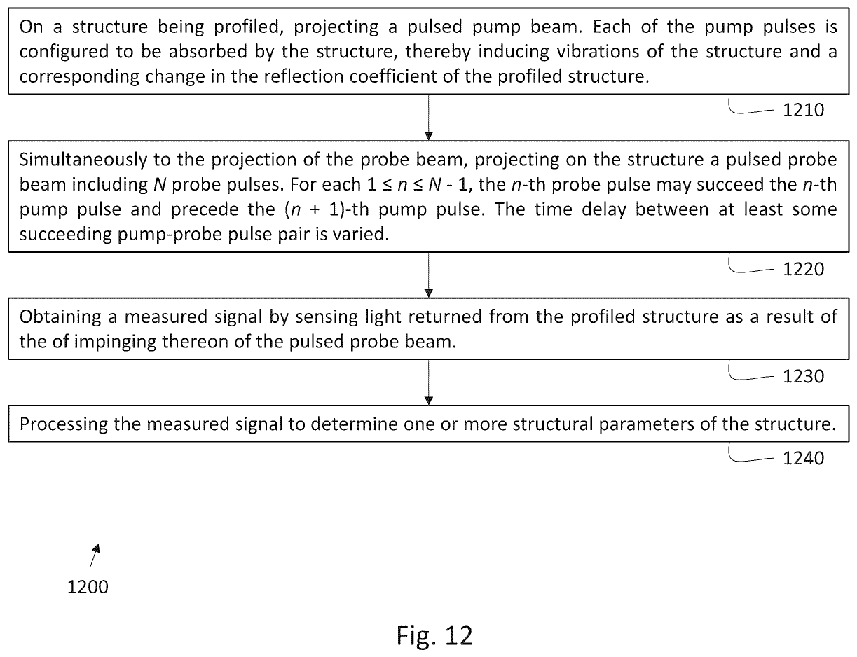

According to some embodiments, and as described below in the description of FIGS. 8, 9A, 9B, 11, and 12, the pump beam may be pulsed (e.g., the pump beam may be a pulsed laser beam). According to some such embodiments, and as described in more detail below and in the description of FIGS. 9A, 9B, and 12, the probe beam may also be pulsed (e.g., the probe beam may be a pulsed laser beam). More specifically, in some of the latter embodiments (i.e., when the probe beam is also pulsed), the pump pulses and the probe pulses are sequentially projected on the profiled structure with each pump pulse being succeeded by a probe pulse and each probe pulse being succeeded by a pump pulse.

According to some such embodiments, a time interval by which each probe pulse is delayed relative to the directly preceding pump pulse may differ from one pump-probe pulse pair to the next. As a non-limiting example, for any 2≤k≤K−1, wherein K is the number of probe pulses (and pump pulses), the k-th probe pulse may delayed by a respective time delay Δtₖ relative to the k-th pump pulse, wherein Δtₖ₋₁≤Δtₖ≤Δtₖ₊₁. It is noted that in embodiments, wherein each of the pump pulses excites M≥2 acoustic resonant modes, differently delayed probe pulses will generally impinge on the profiled structure when different (resonant vibration) phases, respectively, are realized. For example, an i-th probe pulse, delayed by Δtᵢ, may impinge when a set of phases {φₘ⁽ⁱ⁾}ₘ₌₁^{M} is realized, and a j-th probe pulse, delayed by Δtᵢ, may impinge when a set of phases {φₘ^{(j)}}ₘ₌₁^{M}≠{φₘ⁽ⁱ⁾}ₘ₌₁^{M} is realized. Here φₙ⁽ⁱ⁾ denotes the phase of the n-th excited (resonant) vibration mode when impinged by a probe pulse delayed by Δtᵢ.

According to some embodiments, min{Δtₖ}ₖ₌₁^{K} may be selected so as to ensure that a probe pulse impinges on the profiled structure while resonant vibrations dominate in the sense that non-resonant vibrations have died out or have at least undergone significant attenuation.

According to some embodiments, the pump beam and the probe beam may originate from the same laser source with a beam splitter being used to split an initial laser beam, generated by the laser source, into a first laser beam and a second laser beam, as described, for example, below in the description of FIG. 9A. The pump beam is constituted by, or prepared from, the first laser beam. The probe beam is constituted by, or prepared from, the second laser beam. According to some embodiments, a harmonic generation unit may be used to set the wavelengths the pump beam and/or the probe beam (e.g., by frequency doubling and/or generation of higher harmonics out of the fundamental wavelength).

According to some embodiments, wherein the pump beam is pulsed, parameters of the pump beam, in particular, a wavelength of the carrier, may be selected so as to maximize, or substantially maximize, a change, or relative change, in the reflection of the probe beam from the profiled structure (i.e., due to the projection thereon of the pump beam), and, therefore, a change in the reflection coefficient of the profiled structure. This in turn may manifest as a strong peak(s) (due to increased reflectance) and/or dip(s) (due to increased absorbance) in (i) the periodogram of the measured signal (e.g., when the temporal dependence of the intensity of the returned light beam, optionally, after filtering thereof, is measured) or (ii) the measured spectrum (when an ultra-high-resolution spectrometer is employed to measure the spectrum of the returned light beam, optionally, after filtering thereof).

According to some embodiments, parameters of the probe beam may be selected such that |ΔR(ƒ)| or |ΔR(ƒ)/R| is maximum, or substantially maximum. Here R denotes the reflection coefficient of the profiled structure when still (i.e., when the profiled structure is not vibrating). R(ƒ) denotes the reflection coefficient of the profiled structure associated with (mechanical) vibration at an (excitation) resonant frequency ƒ. AR(ƒ)=R−R(ƒ). The vertical bars denote absolute value. According to some embodiments, wherein the pump beam is pulsed, so that mechanical vibrations across continuous range of frequencies are excited by each pump pulse, and a fast optical detector is employed to measure the intensity of the returned component of the probe beam, R(ƒ) may be obtained through spectral analysis (involving implementation of a Fourier transform). Alternatively, according to some embodiments, wherein the pump beam is pulsed and an ultra-high-resolution spectrometer is employed to sense the returned component of the probe beam, R(ƒ) may be directly measured. More generally, according to some embodiments parameters of the probe beam may be selected to maximize the change in reflection, or the relative change in reflection, associated with a plurality of resonant frequencies.

Noting that the reflection coefficient also depends on the wavelength of the probe beam, according to some embodiments, the wavelength of the probe beam may be selected so as to produce the maximum change in the reflection coefficient, as elaborated on below.

According to some embodiments, the frequency of the envelope of the pump pulses may be swept over a plurality of frequency windows (i.e., frequency ranges). The size and location of each frequency window may be selected to include a respective resonant frequency (also termed “resonance frequency”) pertaining to a specific vibration pattern. Since initially (i.e., prior to implementing method 100) the geometry of the profiled structure is not accurately known (i.e., not known to a required precision), the resonant frequencies (i.e., the exact values thereof) are initially unknown. However, a frequency window—within which the resonant frequency is expected to fall—may be determined based on past data acquired, e.g., by profiling structures of the same intended design as the (currently) profiled structure, and/or design data (of the profiled structure). According to some embodiments, by sweeping the frequency of the envelope over a number of distinct frequency windows, wherein mechanical vibrations of structures (such as the profiled structure) are known to be exhibited, rather than over the entire frequency range, throughput may be increased.

According to some embodiments, in operation 130, the measured signal may be obtained using a light sensor configured to measure the temporal dependence of the intensity of the returned light beam I(t) (optionally, after filtering thereof). Such embodiments include embodiments wherein both the pump beam and the probe beam are pulsed, as well as some embodiments wherein the probe beam is continuous-wave. In the latter embodiments, the light sensor may be a fast optical detector, which together with associated fast electronics (with a bandwidth on the order of tens of GHz, comparable to the frequencies of the induced vibrations), allows obtaining the measured signal to high temporal resolution. Generally, I(t)=I_{DC}+ΔI(t). I_{DC}, the “DC component” of I(t), corresponds to contribution to I(t), which on the scale of the lifetime of the excited resonant modes is constant or near constant. ΔI(t) corresponds to the transient (or “AC”) component of I(t), and as such includes a contribution from the reflected component of the probe beam. According to some embodiments, the pump beam may be modulated so as to allow isolating the contribution, due to the induced vibrations, of the reflected component of the probe beam to ΔI(t) using a lock-in amplifier, as elaborated on below.

According to some alternative embodiments, wherein the pump beam is pulsed and the probe beam is continuous-wave, in operation 130, an ultra-high-resolution spectrometer, e.g., having a resolution of ˜1 GHz, may be employed to directly detect the resonant frequencies. In such embodiments, the measured signal I(ƒ) specifies the intensity of the returned light beam (optionally, after filtering thereof) as a function of the frequency thereof.

According to some embodiments, in operation 130, a light sensing assembly including a plurality of light sensors or a light sensor array may be employed in order to sense a plurality of returned light beams (or a plurality of components of a returned light beam), which differ from one another in one or more of wavelength, return angle, and polarization. According to some embodiments, one or more light sensors may be employed to sense backscattered light (e.g., in addition to specularly reflected light and/or diffracted light).

According to some embodiments, the lateral dimensions of structures in a profiled site (i.e., a site on a sample including one or more profiled structures) may be significantly smaller than the spot size of the pump beam and the spot size of the probe beam, which may be in the micrometer range. Accordingly, in such embodiments, at least some of the structural parameters computed in operation 140 may correspond to averages. Non-limiting examples include the average width and/or average height of a plurality fins included within the spot formed by the probe beam (and that of the pump beam), the average width and/or depth of a plurality of trenches included within the spot formed by the probe beam (and that of the pump beam), and so on.

Referring also to FIG. 1B, FIG. 1B presents a flowchart of suboperations of an operation 140′, which corresponds to specific embodiments of operation 140 of method 100. Operation 140′ includes:
A suboperation 140a′, wherein frequencies of excited resonant modes are extracted from the measured signal, optionally, after subjecting the measured signal to initial processing (e.g., computing the Fourier transform thereof when the measured signal is temporal, demodulating the measured signal when the pump beam is prepared modulated).
A suboperation 140b′, wherein (the values of) the one or more structural parameters of the profiled structure are determined based at least on the frequencies of the excited resonant modes.

According to some embodiments, wherein the measured signal is time-dependent (i.e., depends on the time by which a probe pulse is delayed relative to a directly preceding probe pulse), suboperation 140a′ may include an initial suboperation wherein a Fourier transform algorithm (e.g., fast Fourier transform) is applied to ΔI(t), optionally, after initial processing of the (raw) measured signal. According to some embodiments, wherein the pump beam is modulated so as to facilitate isolating a contribution to the reflected portion of the probe beam due to the induced vibrations (of the profiled structure), such initial processing may include demodulation of ΔI(t) using a lock-in amplifier: In the thus obtained demodulated signal ΔI_{dm}(t), noise and background signals are substantially removed, or at least significantly reduced, and the contribution to the reflected portion of the probe beam due to the induced vibrations is amplified.

To obtain the values of the excited resonant frequencies—depending on the specific realization of operations 110-130—sizable peaks and/or dips are identified in ΔĨ(ƒ), ΔĨ_{dm}(ƒ), or I(ƒ) (i.e., the measured spectrum in embodiments wherein the measured signal is obtained using an ultra-high-resolution spectrometer). Here ΔÍ(ƒ) denotes the Fourier transform ΔI(t) while ΔI_{dm} (ƒ) denotes the Fourier transform of ΔI_{dm}(t). As used herein, the term “sizable” in reference to a peak implies that the (average) intensity, or relative intensity, of the peak is above a top threshold intensity (e.g., at a signal-to-noise ratio at which the peak is stable). Similarly, the term “sizable” in reference to a dip implies that the (average) intensity, or relative intensity, of the dip is below a bottom threshold intensity. According to some embodiments, each peak and dip may only be sought (i.e., looked for), or first be sought, within a respective frequency window wherein the peak or the dip is expected to fall based on past data acquired e.g., by profiling structures of the same intended design as the (currently) profiled structure and/or design data (of the profiled structure). Once identified, the exact value of the resonant frequency corresponding to a peak or a dip is obtained by localizing the peak or the dip, e.g., by computing the “center-of-mass” of the peak or the dip.

According to some embodiments, in operation 140b′ additional parameters, which characterize the excited resonant modes beyond the frequencies thereof, may be taken into account in determining the values of the one or more structural parameters. According to some embodiments, the additional parameters may include the sizes of the peaks (i.e., the intensities of the peaks) and/or dips corresponding to the excited resonant modes, respectively. More generally, according to some embodiments, the additional parameters may further include other parameters characterizing the shapes of the peaks and/or dips beyond the sizes thereof, such as that the heights and widths of the peaks and the depths and/or widths of the dips. According to some embodiments, the uncertainties in the computed frequencies (and, optionally, the computed values of the additional parameters) of the excited resonant modes may also be taken into account in determining the values of the one or more structural parameters.

According to some embodiments, in operation 140b′ the one or more structural parameters of the profiled structure are obtained by executing an algorithm, which has been trained to correlate between frequencies of resonant mode excitations (i.e., the obtained resonant excitation spectrum) optionally, as well as values of additional parameters characterizing the resonant mode excitations and values of structural parameters of structures of the same intended design as the profiled structure. The values of the structural parameters may be constituted by ground-truth data. The ground-truth data may be obtained using, for example, scanning and/or transmission electron microscopy to profile a plurality of sites on lamellas extracted from the structures and/or slices shaved thereof. More specifically, the sites on each lamella or slice are profiled, thereby obtaining the values of structural parameters (e.g., the average height and width of the fins) at each of the sites. According to some embodiments, the thus obtained values of the structural parameters may then be averaged to obtain representative of the structure as a whole. Accordingly, the sites may be selected to be substantially uniformly distributed over the lamellas and/or slices.

According to some such embodiments, the algorithm may be or incorporate a neural network.

According to some embodiments, the architecture of the algorithm (e.g., values of the weights of the neural network) may depend on parameters characterizing the pump beam and/or the probe beam. According to some embodiments, the inputs of the algorithm may further include raw or processed measurement data of the profiled structure obtained using other techniques (and tools), such as scanning electron microscopy, OCD scatterometry, and/or SAXS.

According to some alternative embodiments, in operation 140b′ the one or more structural parameters of the profiled structure may be obtained by conducting an inverse model search in a model database. Each model in the model database corresponds to a respective structure, or, more specifically, a respective set of structural parameters characterizing the structure. Each model specifies a respective spectrum of resonant excitations, which corresponds to the respective set of values of the one or more structural parameters. In the inverse model search, the models, whose resonant excitation spectrum most closely matches the measured resonant excitation spectrum, are identified. The values of the one or more structural parameters of the profiled structure may then be determined through interpolation (from the sets of structural parameters of the identified models).

As used herein, the term “set” is to be understood as covering not only multi-element sets (e.g., specifying values of at least two structural parameters) but also single element sets (e.g., specifying a value of a single structural parameter).

According to still other embodiments, operation 140 may be implemented by executing an algorithm configured to (i) receive as an input the measured signal (i.e., without initial processing) and (ii) output values of one or more structural parameters characterizing a geometry and/or a material composition of the profiled structure.

According to some embodiments, method 100 may be applied to structures whose intended design is characterized by periodic, or substantially periodic, geometry along one of their dimensions, such as, for example, the profiled structure depicted in FIG. 2. In such embodiments, the vibrations induced in operation 110 may include vibrations along the dimension exhibiting, or substantially exhibiting, the periodicity.

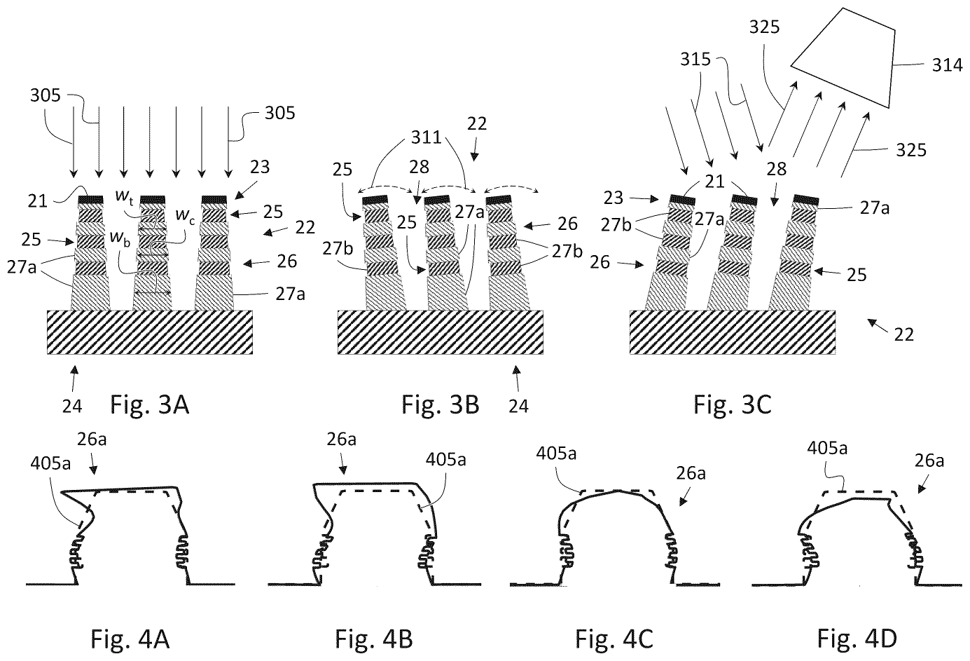

To facilitate the description, reference is additionally made to FIG. 2 and FIGS. 3A-3C. FIG. 2 presents a perspective view of a (profiled) structure 22 including a base portion 24 and a plurality of fins 26 positioned on base portion 24. Each of fins 26 forms an elongated ridge-like structure, which projects upwards (that is, vertically along the positive z-axis per the Cartesian coordinate system depicted in FIG. 2) from base portion 24. Trenches 28 extend between fins 26. Also indicated are top surfaces 21 of fins 26. According to some embodiments, and as depicted in FIG. 2, fins 26 are of the same design and are arranged in parallel, or substantially in parallel, to one another. Structure 22 is thus characterized by a geometry, which is periodic, or substantially periodic, along the (lateral) y-axis, and uniform, or substantially uniform, along the (lateral) x-axis. In particular, the geometry of structure 22 is conducive to the excitation of collective vibrations of fins 26 (i.e., wherein the motion of the fins is correlated) and is thus amenable to photo-acoustic profiling using method 100.

According to some such embodiments, structure 22 may be a preliminary structure in one of the fabrication stages of a fin field-effect-transistor (FinFET), a gate-all-around transistor, or a similar structure, which may be positioned on a wafer (not shown), optionally, in one of the fabrication stages of the wafer. In such embodiments, structure 22 may be made of silicon and/or one or more other materials, which are used in the semiconductor industry.

FIGS. 3A-3C schematically depict stages in an implementation of method 100, according to some embodiments thereof. More specifically, FIGS. 3A-3C depict successive stages in a photo-acoustic profiling of structure 22 in accordance with method 100. In FIG. 3A an optical pump beam 305 is shown projected on structure 22 in accordance with operation 110, according to some embodiments thereof. Pump beam 305 is absorbed by structure 22 at least by top portions 23 of fins 26. The absorption of pump beam 305 results in the heating of structure 22. The heating of structure 22 gives rise to internal structure stresses in structure 22 and ensuing vibrations of structure 22. Double-headed arrows 311 in FIG. 3B indicate motion of top portions 23 (due to the vibrations of structure 22). The vibrations may in turn modify the reflection coefficient of structure 22. In FIG. 3C an optical probe beam 315 is shown projected on structure 22, in accordance with operation 120. A returned beam 325, reflected off structure 22, is sensed by a light sensor 314 to obtain a measured signal, in accordance with operation 130, according to some embodiments thereof.

The vibrations may include lateral (e.g., in parallel to they-axis) and/or vertical vibrations (in parallel to the z-axis). According to some embodiments, the vibrations may be dominated by resonant vibrations, i.e., vibrations induced by the excitation of acoustic resonances in structure 22.

The skilled person will realize that more complex lateral vibrational patterns than those depicted in FIGS. 3A-3C may be induced, for example, as depicted in FIGS. 4A-4D. FIGS. 4A-4D depict structure 22 undergoing lateral vibrations induced by impinging thereon of a pump beam in accordance with method 100, according to some embodiments thereof. Only a single fin from fins 26, a fin 26a, is depicted. More specifically, FIGS. 4A-4D shows fin 26a at four successive times, respectively, during excitation of a higher-frequency (lateral) vibration mode. A dashed outline 405a delineates the profile of fin 26a when still. As seen in FIG. 4B, in higher-frequency vibration modes, different lateral segments of a fin may be displaced in opposite directions.

According to some embodiments, a plurality of acoustic resonant modes may be simultaneously excited (e.g., when the frequency range of the pump beam is sufficiently broad, as is the case for a short-pulsed pump beam) or excited in close succession (e.g., when the pump beam is modulated by a specific resonant frequency), such that the profiled structure simultaneously vibrates at the specific (excited) resonant frequencies.

Referring again to FIGS. 3A-3C, according to some embodiments, using method 100, shapes and dimensions of fins 26, including heights thereof, widths at different depths thereof (e.g., near the top, center, and bottom of a fin, as indicated in FIG. 3A by widths wₜ, w_{c}, and w_{b}, respectively) of the fins, as well as distances between adjacent fins, may be estimated (in operation 140) from the measured signal (obtained in operation 130). According to some embodiments, wherein fins 26 include recesses 25, the shape and/or dimensions of the recesses may also be estimated from the measured signal.

According to some embodiments, each of fins 26 may have a layered structure, wherein two or more types of layers are stacked on top of one another. As a non-limiting example, according to some embodiments and as depicted in FIGS. 3A-3C, fins 26 may include first layers 27a (i.e., layers having a first material composition) and second layers 27b (i.e., layers having a second material composition), which are alternately disposed one on top of the other.

FIGS. 5A-5D schematically depict four types of mechanical vibrations, respectively, which may be induced in a structure when subjecting the structure to profiling according to some embodiments of method 100. More specifically, in each of FIGS. 5A-5D a (profiled) structure 52 is depicted. Structure 52 includes a base portion 54 from which fins 56 (only one of fins 56, a fin 56a is shown in FIG. 5A) vertically extend. Structure 52 corresponds to specific embodiments of structure 22. Each of fins 56 laterally extends in parallel to the x-axis.

In FIG. 5A structure 52 is shown undergoing lateral vibrations (indicated by double-headed arrows 511). These lateral vibrations (also termed “flexural modes”) may be induced via the excitation of acoustic resonance modes in structure 52 by projecting thereon a pump beam in accordance with operation 110 of method 100, according to some embodiments thereof. A first dashed outline 513a′ delineates the profile of fin 56a when tilted in the direction of the positive y-axis due to the lateral vibrations undergone thereby. A second dashed outline 513a″ delineates the profile of fin 56a when tilted in the direction of the negative y-axis due the lateral vibrations undergone thereby.

By obtaining a measured signal through the impinging of a probe beam on structure 52 while structure 52 undergoes lateral vibrations (induced by a pump beam), and processing the measured signal (as explained above in the description of operations 120, 130, and 140, according to some embodiments thereof), values of one or more resonant frequencies of the lateral vibrations are extracted. From these one or more values, information indicative of the (external) geometry of fins, such as the average height of the fins, the average widths thereof as a function of the vertical coordinate (which quantifies the height), an average tilt angle thereof, and average dimensions of recesses (not shown in FIG. 5A) on the fins, may be obtained.

In FIG. 5B structure 52 is shown undergoing vertical vibrations (indicated by double-headed arrows 521). These vertical vibrations may be induced via the excitation of acoustic resonance modes in structure 52 by projecting thereon a pump in accordance with operation 110, according to some embodiments thereof. The vertical vibrations cause structure 52 and, in particular, each of fins 56 (only fin 56a is shown in FIG. 5B), to alternately vertically expand and vertically contract. A first dashed outline 523a′ delineates the profile of fin 56a when vertically expanded due to the vertical vibrations undergone thereby. A second dashed outline 523a″ delineates the profile of fin 56a when vertically contracted due to the vertical vibrations undergone thereby.

By obtaining a measured signal through the impinging of a probe beam on structure 52 while structure 52 undergoes vertical vibrations (induced by a pump beam), and processing the measured signal (as explained above in the description of operations 120, 130, and 140, according to some embodiments thereof), one or more resonant frequencies of the vertical vibrations are extracted. From these one or more resonant frequencies information indicative of the mean (i.e., average) height of the fins, as well as of the mean vertical widths of each of the layers making up the fins when the fins are composed of two or more layers (as depicted, for example, in FIGS. 3A-3C), may be obtained.

According to some embodiments, wherein both lateral and vertical resonant vibration patterns are excited by the pump beam, the measured signal may be processed to extract the resonant frequencies of each of the excited resonant vibration patterns. The extracted resonant frequencies of both lateral and vertical vibrations patterns may be jointly processed to obtain information indicative of the structure of the fins. The joint processing may potentially increase the estimation precision of geometrical features to which both lateral and vertical vibration patterns are sensitive, e.g., the average height of the fins.

FIG. 5C shows a vibration pattern resulting from the excitation of surface acoustic modes in base portion 54, and which may be induced by projecting a pump beam on structure 52 in accordance with operation 110, according to some embodiments thereof. These surface acoustic modes manifest as variations, dependent on they-coordinate, in the height of a top surface 59 of base portion 54, as indicated by arrows 531.

By obtaining a measured signal through the impinging of a probe beam on structure 52 while base portion 54 undergoes surface vibrations (induced by a pump beam), and processing the measured signal (as explained above in the description of operations 120, 130, and 140, according to some embodiments thereof), one or more resonant frequencies of the surface vibrations are extracted. From these one or more resonant frequencies information indicative of the average pitch p (indicated in FIG. 5C) of the fins, as well as a material composition of base portion 54, may be obtained.

In FIG. 5D shows a vibration pattern resulting from the excitation of surface acoustic modes in each of fins 56 (only fin 56a is shown in FIG. 5D), and which may be induced by implementing operation 110, according to some embodiments thereof. These surface acoustic modes manifest as variations, dependent on the x-coordinate, in the height of the top surfaces of fins 56, as illustrated with respect to a top surface 51a of fin 56a. The x-coordinate dependent vertical displacement of top surface 51a is indicated by arrows 541.

By obtaining a measured signal through the impinging of a probe beam on structure 52 while fins 56 undergo surface vibrations (induced by a pump beam), and processing the measured signal (as explained above in the description of operations 120, 130, and 140, according to some embodiments thereof), one or more resonant frequencies of the surface vibrations of fins 56 are extracted. From these one or more resonant frequencies, information indicative of the structure of the fins, such as the average widths of the top surfaces of the fins, midsections of the fins, and the bases of the fins, may be obtained.

According to an aspect of some embodiments, there is provided a computerized system for metrology of structures. FIG. 6 presents a block diagram of such a computerized system, a computerized system 600, according to some embodiments. A sample 60 includes (as depicted in FIG. 6) or constitutes a (profiled) structure 62. Structure 62 may be similar to structure 22. It is to be understood that sample 60 and structure 62 do not form part of system 600.

System 600 includes an optical setup 602 and a processing circuitry 604. Optical setup 602 includes light generating equipment 612 and a light sensing assembly 614. Light sensing assembly 614 includes one or more light sensors and/or a light sensor array (not shown). Optical setup 602 may further include a controller 618 functionally associated with components of optical setup 602 and/or communicatively associated with processing circuitry 604. Light generating equipment 612 is configured to project an (optical) pump beam (represented by a first arrow A₁) on structure 62. The pump beam is configured to induce mechanical (acoustic) vibrations in structure 62, as described above in the description of method 100, and as further elaborated on below. Light generating equipment 612 is further configured to project an (optical) probe beam (represented by a second arrow A₂) on structure 62, while structure 62 is still vibrating (as a result of the absorption of the pump beam).

Light sensing assembly 614 is configured to sense light returned from structure 62. (The returned light is represented by a third arrow A₃). According to some embodiments, light sensing assembly 614 may be configured to measure the instantaneous intensity of the returned light over a time interval, thereby obtaining the time dependence of the intensity of the returned light beam, or at least a transient component thereof, optionally, after filtering of the returned light beam. Additionally or alternatively, according to some embodiments, light sensing assembly 614 may be configured to measure the spectrum of the returned light beam, optionally, after filtering of the returned light beam.

Measurement data (i.e., a measured signal; represented by a fourth arrow A₄), obtained by light sensing assembly 614, are relayed to processing circuitry 604 (either directly or via controller 618). Processing circuitry 604 is configured to extract from the measurement data information indicative of a geometry and/or a material composition of structure 62. To this end, processing circuitry 604 may be configured to first extract from the measurement data at least the frequencies of excited resonant modes. According to some embodiments, and as detailed below in the description of FIG. 9A, a measured signal may include a plurality of intensity values obtained as a result of projecting alternating pump pulses and probe pulses.

According to some embodiments, light generating equipment 612 may include two light generators: a first light generator configured to produce the pump beam and a second light generator configured to produce the probe beam. According to some embodiments, light generating equipment 612 may include one or more coherent light sources (e.g., laser sources) configured to generate the pump beam and the probe beam.

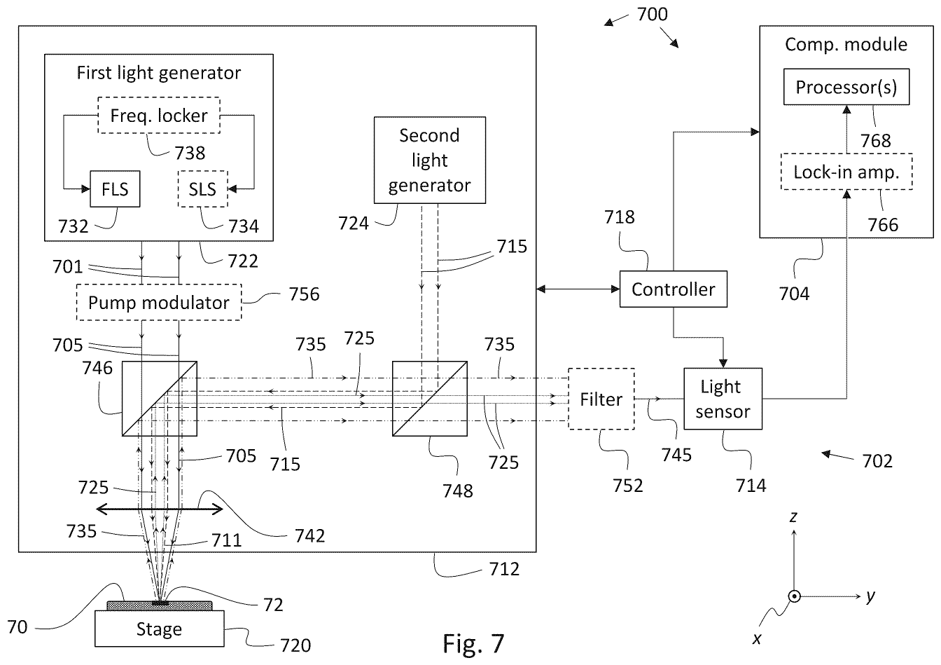

According to some embodiments, light generating equipment 612 may be configured to generate continuous-wave light beams and/or pulsed light beams. That is, the pump beam may be continuous-wave or pulsed and the probe beam may be continuous-wave or pulsed, as described above in the description of method 100 and as further elaborated on below in the description of FIGS. 7-12. According to some embodiments, light generating equipment 612 may be configured to produce amplitude-modulated pump beams, whose modulation frequency is swept over, or swept over one or more subranges (frequency windows) in, the 1 GHz to 100 GHz frequency range, the 1 GHz to 100 GHz range, the 0.5 GHz to 200 GHz range, or even the 0.2 GHz to 500 GHz range. Each possibility corresponds to separate embodiments.

According to some embodiments, in order to facilitate isolating a contribution to the returned light beam of a transient component of a reflected portion of the probe beam, due to the induced vibrations, light generating equipment 612 may be configured to amplitude-modulate an envelope of the pump beam at a modulation frequency on the order 1 MHz. Accordingly, in some such embodiments the pump beam is amplitude-modulated twice: once at a modulation frequency, which is swept over the e.g., 1 GHz to 100 GHz range, and once at a modulation frequency on the order of e.g., 1 MHz.

According to some embodiments, light generating equipment 612 may be configured to allow controllably setting and adjusting the waveforms of the produced pump beam and/or the produced probe beam. According to some embodiments, light generating equipment 612 may be configured to allow controllably setting a polarization of the pump beam and/or a polarization of the probe beam.

Controller 618 may be configured to control and synchronize operations of the various components of optical setup 602. According to some embodiments, controller 618 may be configured to send to processing circuitry 604 information regarding operational parameters of optical setup 602, Non-limiting examples include parameters characterizing the pump beam and/or the probe beam, such as waveforms and intensities thereof, and, in particular, a modulation frequency of the pump beam, or, in some embodiments wherein the pump beam is doubly amplitude-modulated, a pair of modulation frequencies of the pump beam.

Processing circuitry 604 includes computer hardware (one or more processors, and, optionally, volatile and/or non-volatile memory components; not shown) configured to determine one or more structural parameters indicative of a geometry and/or a material composition of structure 62, based at least on the measurement data, relayed from light sensing assembly 614. More specifically, according to some embodiments, the computer hardware may be configured to process the measurement data to extract therefrom the frequencies of excited resonant modes, and, based on the extracted frequencies, determine (the values of) the one or more structural parameters. The processing of the measurement data may include identifying sizable peaks and/or dips in a periodogram of the measured signal, optionally, after initial processing of the measured signal. The initial processing may include: (i) application of a Fourier transform algorithm, when the measured signal is temporal, as described above in the description of FIG. 1B, and/or (ii) demodulation of the envelope of the pump beam in embodiments wherein the pump beam is amplitude-modulated in order to facilitate isolating (through the demodulation) a contribution to the measured signal of a transient component of a reflected portion of the probe beam, as described above in the description of method 100.

According to some embodiments, the one or more processors may be further configured to extract from the measurement data values of one or more additional parameters, which individually characterize the excited resonant modes, such as the dimensions of corresponding peaks and/or dips. In such embodiments, the computer hardware may be configured to determine the one or more structural parameters further taking into account the values of the additional parameters. To this end, the one or more processors may be configured to execute an algorithm(s) (e.g., trained using machine-learning tools) configured to receive as inputs the extracted frequencies of the resonant modes, and, optionally, the values of the one or more additional parameters, as described above in the description of operation 140 of method 100 according to some embodiments thereof. According to some embodiments, the algorithm(s) may include a neural network(s). According to some embodiments, the neural network(s) may be trained using ground truth data, as described above in the description of operation 140 of method 100 to some embodiments thereof.

According to some alternative embodiments, the one or more processors may be configured to determine (the values of) the one or more structural parameters by searching a reference library (e.g., a model database), essentially as described above in the description of operation 140 of method 100 to some embodiments thereof. More specifically, the one or more processors may be configured to identify in the reference library a reference(s) (e.g., a model(s)) specifying frequencies of resonant modes (and, optionally, additional parameters characterizing the resonant modes), which most closely match the measured frequencies of the excited resonant modes (and, optionally, the additional parameters characterizing the resonant modes) obtained with respect to structure 62.

According to some embodiments, processing circuitry 604 and controller 618 may be housed in a common housing, for example, when implemented by a single computer.

According to some embodiments, light generating equipment 612 may be configured to project on structure 62 a plurality of pump beams, so as to form thereon an illumination pattern. The illumination pattern may be static, time-dependent, or even travelling (i.e., being (spatially) translated along the top surface of the structure). The illumination pattern may be selected so as to help excite additional resonant vibrations in structure 62 and/or strengthen the magnitude of excited resonant vibrations. For example, according to some embodiments, the illumination pattern may be selected to substantially match the spatial and temporal profile of an excited resonant surface acoustic mode (such as the surface acoustic mode depicted in FIG. 5D). To this end, light generating equipment 612 may be configured to produce two pump beams, which slightly differ in wavelength and/or in the angle of incidence thereof. More generally, according to some embodiments, at least some of the pump beams may differ from one another in one or more of wavelength, incidences angle, azimuth angle, polarization, and numerical aperture. According to some embodiments, at least some of the pump beams may be configured to strike structure 62 at different locations thereon.

According to some embodiments, light generating equipment 612 may be configured to project on structure 62 a plurality of probe beams, which may differ from one another in one or more of wavelength, incidences angle, azimuth angle, polarization, numerical aperture, and striking location on structure 62.

According to some embodiments, the one or more light sensors of light sensing assembly 614 include a plurality of light sensors configured to sense a plurality of returned light beams, which differ from one another in one or more of wavelength, return angle, and polarization. According to some embodiments, a light sensor array may be used to the same end. According to some embodiments, light sensing assembly 614 may be configured to sense backscattered light (e.g., in addition to specularly reflected light and/or diffracted light).

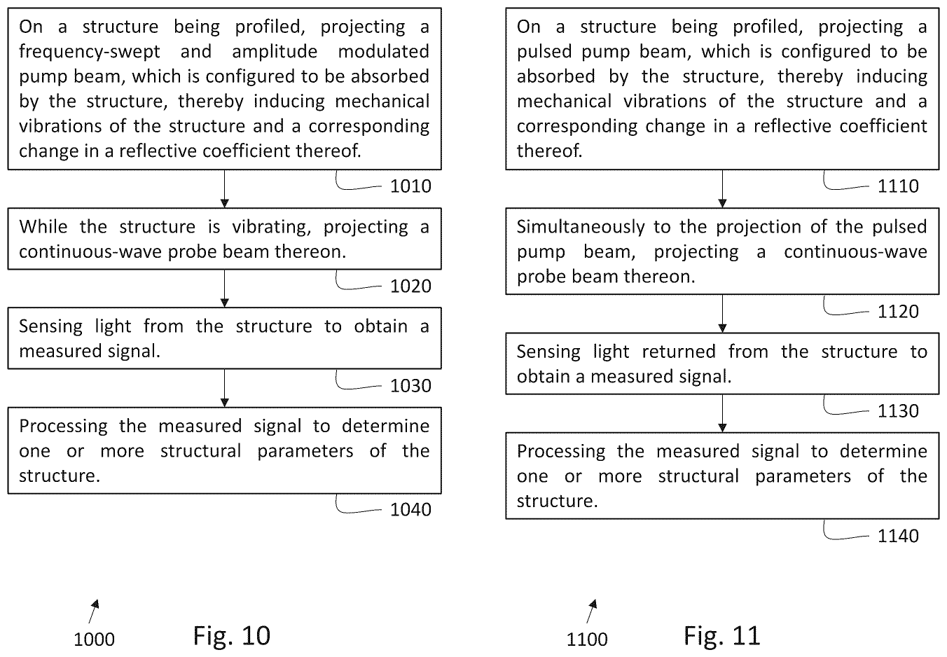

FIGS. 7, 8, and 9A and 9B depict four systems (in FIG. 9B the system is only depicted in part), which correspond to different specific embodiments, respectively, of system 600. FIGS. 10-12 describe three methods, which correspond to different specific embodiments, respectively, of method 100. As seen in Table 1, the method of FIG. 10 may be implemented using the system of FIG. 7, the method of FIG. 11 may be implemented using the system of FIG. 8, and the method of FIG. 12 may be implemented using the system of FIG. 9A or the system of FIG. 9B. More precisely, Table 1 specifies per each specific embodiment, general properties of the pump beams and the probe beams utilized.

TABLE 1

| | | Pump beam is |
|---|---|---|
| | | continuous-wave and |
| | Pump beam is pulsed | frequency swept |
| Probe beam is pulsed | FIGS. 9A, 9B, and 12 | |
| Probe beam is | FIGS. 8 and 11 | FIGS. 7 and 10 |
| continuous-wave | | |

FIG. 7 schematically depicts a computerized system 700, which corresponds to specific embodiments of system 600. System 700 includes an optical setup 702 and a processing circuitry 704, which correspond to specific embodiments of optical setup 602 and processing circuitry 604, respectively. Also depicted is a sample 70 including a (profiled) structure 72, which is shown being profiled by system 700. Sample 70 and structure 72 correspond to specific embodiments of sample 60 and structure 62, respectively. It is to be understood that sample 70 and structure 72 are not included in system 700. Optical setup 702 includes light generating equipment 712, a light sensing assembly 714, and a controller 718, which correspond to specific embodiments of light generating equipment 612, light sensing assembly 614, and controller 618, respectively. Light sensing assembly 714 includes one or more light sensors and/or a light sensor array. Also indicated is a stage 720 (e.g., a xyz stage) on which sample 70 is placed.

Light generating equipment 712 includes a first laser generator 722 and a second laser generator 724. First laser generator 722 and second laser generator 724 are configured to produce a laser beam 701 and a probe beam 715 (indicated by dashed lines), respectively. Each of laser beam 701 and probe beam 715 may be a continuous-wave laser beam. According to some embodiments, first laser generator 722 may be configured to produce a continuous-wave laser beam, which is amplitude-modulated at a (first) modulation frequency ƒ(t) (also referred to as “the excitation modulation frequency”), i.e., a continuous-wave laser beam whose (amplitude) modulation frequency (i.e., the frequency of the envelope) is swept over a frequency range in real-time. More specifically, according to some embodiments, first laser generator 722 includes a frequency-sweep laser source. According to some such embodiments, the intensity of laser beam 701 is given by Iₚᵤₘₚ(t)=I₀·(1+sin(4πƒ(t)·t)), wherein the first modulation frequency is a function of t—the time passed since the initial generation of the pump beam. As a non-limiting example, according to some embodiments, ƒ(t) may be proportional to t. According to some embodiments, the first modulation frequency is varied across a frequency range, or one or more frequency ranges, included in the 0.2 GHZ to 500 GHz range.

According to some embodiments, and as depicted in FIG. 7, first laser generator 722 includes a first laser source (FLS) 732, a second laser source (SLS) 734, and a frequency locker 738. First laser source 732 may be configured to produce a first laser beam characterized by an electric field E₁(t)=\sqrt{I₀}exp(i2π(ƒ₀+ƒ)t), wherein ƒ<<ƒ₀. Second laser source 734 may be configured to produce a second laser beam characterized by an electric field E₂(t)=\sqrt{I₀}exp(i2π(ƒ₀−ƒ)t). The frequency difference 4ƒ between the first and second laser beams may be controllably set and varied by frequency locker 738. First laser generator 722 may include optics configured to merge the first and second laser beams. The intensity of the merged laser beam can be shown to equal Iₚᵤₘₚ(t)=|E₁+E₂|²≈I₀·(1+sin(4πƒ·t)), so that by varying ƒ, the modulation frequency of the merged laser beam (i.e., the (first) modulation frequency of the pump beam) is changed.

According to some alternative embodiments, not depicted in FIG. 7, first laser generator 722 may include a single laser source, and light generating equipment 712 may include a frequency modulator configured to controllably vary in real-time the first modulation frequency of the (pump) laser beam produced by the laser source of first laser generator 722.

According to some embodiments, second laser generator 724 may be configured to produce probe beam 715 to be mono-frequency or narrowly concentrated about a single frequency, which is selectable. According to some embodiments, second laser generator 724 may be configured to adjust the frequency of probe beam 715 in real-time.

According to some embodiments, and as depicted in FIG. 7, light generating equipment 712 may further include an objective lens 742, a first beam splitter 746, and a second beam splitter 748, and optical setup 702 may further include an optical filter 752.

According to some embodiments, and as depicted in FIG. 7, light generating equipment 712 further includes a pump modulator 756, and processing circuitry 704 further includes a lock-in amplifier 766, whose functions are described in detail below. In particular, in some such embodiments, pump modulator 756 is used to finish preparing the pump beam (which goes on to impinge on structure 72) through amplitude-modulation (a second time) of laser beam 701. Alternatively, according to some embodiments, wherein light generating equipment 712 does not include pump modulator 756, laser beam 701 may constitute the pump beam impinging on structure 72.

In operation, first laser generator 722 produces a frequency-swept laser beam 701 and second laser generator 724 produces probe beam 715. According to some embodiments, and as depicted in FIG. 7, laser beam 701 is amplitude-modulated a second time by pump modulator 756 at a second modulation frequency, thereby producing a pump beam 705. According to some embodiments, the second modulation frequency may be between about 1 MHz and 10 MHz. According to some embodiments, the second modulation frequency is lower by about at least one order of magnitude than the minimum value assumed by ƒ(t). According to some embodiments, the second amplitude-modulation (i.e., by pump modulator 756) is intended to facilitate isolating a contribution to the measured signal of a reflected portion of probe beam 715, while the first amplitude-modulation is used to excite mechanical vibrations at a controllable frequency—i.e., the excitation modulation frequency set by frequency locker 738.

According to some embodiments, and as depicted in FIG. 7, prior to impinging on structure 72, pump beam 705 may be focused by objective lens 742 (optionally, after passage via first beam splitter 746). Similarly, according to some embodiments, and as depicted in FIG. 7, prior to impinging on structure 72, probe beam 715 may be focused by objective lens 742 (optionally, after passage via second beam splitter 748 and reflection by first beam splitter 746).

Pump beam 705 is absorbed by structure 72 resulting in the heating of structure (e.g., of a top layer of structure 72) and commensurate expansion of structure 72. The magnitude of the expansion depends on the amount of heat absorbed per unit time, which in turn depends on the intensity of pump beam 705. Since pump beam 705 is amplitude-modulated, the amount of heat absorbed per unit time is not constant, and a mechanical vibration(s) at the instantaneous first modulation frequency ƒ(t) is induced in structure 72. Whenever ƒ(t) approaches a resonant frequency of structure 72, the amplitude of the induced vibration sharply increases, which, in turn, manifests as a strong peak/dip in the reflectance curve of probe beam 715.

A first returned beam 725 (indicated by dotted lines) corresponds to a portion of probe beam 715, which is reflected off structure 72. According to some embodiments, and as depicted in FIG. 7, first returned beam 725 travels onto optical filter 752 (optionally, after reflection by first beam splitter 746 and passage via second beam splitter 748). A second returned beam 735 (indicated by dashed-double dotted lines) may correspond to a portion of pump beam 705, which is returned (reflected and/or scattered) from structure 72. According to some embodiments, and as depicted in FIG. 7, second returned beam 735 travels onto optical filter 752 (optionally, after reflection by first beam splitter 746 and passage via second beam splitter 748).

According to some embodiments, optical filter 752 may be configured to transmit therethrough first returned beam 725 while simultaneously attenuating second returned beam 735 relative to first returned beam 725 or substantially fully blocking second returned beam 735. Additionally, or alternatively, according to some embodiments, optical filter 752 may be configured to filter out background noise. A filtered beam 745 corresponds to the output of optical filter 752. According to some embodiments, optical filter 752 may include a spectral filter configured to block light at wavelength outside a (transmittable) wavelength range. According to some such embodiments, the transmittable wavelength range may correspond to the wavelength, or wavelength range, of probe beam 715.

According to some embodiments, first laser generator 722 may be configured to prepare laser beam 701 at a first polarization state and second laser generator 724 may be configured to prepare probe beam 715 at a second polarization state, which is orthogonal to the first polarization state. In such embodiments, optical filter 752 may include a polarization filter.

Light sensing assembly 714 is configured to measure one or more optical parameters of filtered beam 745, thereby obtaining one or more measured signals. According to some embodiments, light sensing assembly 714 may be configured to measure the instantaneous intensity (i.e., continuously measure or sample the intensity) of filtered beam 745, thereby allowing to obtain the time-dependence of the intensity of filtered beam 745. Processing circuitry 704 is configured to process the one or more measured signals to determine one or more structural parameters, which characterize structure 72, as described above in the description of operation 140 of method 100, in the description of processing circuitry 604 of system 600, below in the description of FIG. 10, and as elaborated on next.

More specifically, in embodiments including pump modulator 756 and lock-in amplifier 766, lock-in amplifier 766 may use the second modulation frequency (employed by pump modulator 756 to amplitude-modulate laser beam 701 a second time) to demodulate the measured signal and thereby isolate a contribution thereto due to the induced vibrations of structure 72. From the demodulated signal, after application thereto of a Fourier transform algorithm (e.g., a fast Fourier transform), the induced resonant frequencies may be identified—e.g., by a processor(s) 768 included in processing circuitry 704—as described above in the description of method 100.

While in FIG. 7, the pump beam is shown as passing through a single beam splitter (i.e., first beam splitter 746) in travelling onto sample 70, and the probe beam is shown as passing through a pair of beam splitters (i.e., second beam splitter 748 and first beam splitter) in travelling onto sample 70, the skilled person will readily perceive that this arrangement is arbitrary and may be “inverted”. That is, according to some embodiments (not depicted in FIG. 7), the pump beam may be made to pass through a pair of beam splitters in travelling onto sample 70, and the probe beam may be made to pass through a single beam splitter in travelling onto sample 70.

FIG. 8 schematically depicts a computerized system 800, which corresponds to specific embodiments of system 600. System 800 is similar to system 700 but differs therefrom at least in being configured to generate a pulsed pump beam instead of a continuous-wave pump beam. System 800 includes an optical setup 802 and a processing circuitry 804, which correspond to specific embodiments of optical setup 602 and processing circuitry 604, respectively. Also depicted is a sample 80 including a (profiled) structure 82, which is being profiled by system 800. Sample 80 and structure 82 correspond to specific embodiments of sample 60 and structure 62, respectively. It is to be understood that sample 80 and structure 82 are not included in system 800. Optical setup 802 includes light generating equipment 812, a light sensing assembly 814, and a controller 818, which correspond to specific embodiments of light generating equipment 612, light sensing assembly 614, and controller 618, respectively. Light sensing assembly 814 includes one or more light sensors and/or a light sensor array. Also indicated is a stage 820 (e.g., a xyz stage) on which sample 80 is placed, which may be similar to stage 720. Light generating equipment 812 includes a first laser generator 822 configured to produce a laser beam 801, which may be pulsed, and a second laser generator 824 configured to produce a probe beam 815 (indicated by dashed lines), which may be continuous-wave.

First laser generator 822 is configured to generate a pulsed laser beam 801 (i.e., a train of laser pulses; indicated by a dashed-dotted line). According to some embodiments, light generating equipment 812 may further include a harmonic generation unit (not shown in FIG. 8) configured to allow selectively changing the wavelength of the pump beam relative to that of the probe beam (optionally, in combination with a suitable optical filter) and/or generating a pump beam including a plurality of pump components at different wavelengths (e.g., the first, second, third and/or fourth harmonic).

According to some embodiments, the one or more light sensors of light sensing assembly 814 may include a fast optical detector and/or an ultra-high-resolution spectrometer.

According to some embodiments, and as depicted in FIG. 8, light generating equipment 812 may further include an objective lens 842, a first beam splitter 846, and a second beam splitter 848, which may be similar to objective lens 742, first beam splitter 746, and second beam splitter 748, according to some embodiments thereof Δccording to some embodiments, and as depicted in FIG. 8, optical setup 802 may further include an optical filter 852, which may be similar to optical filter 752, according to some embodiments thereof.

According to some embodiments, and as depicted in FIG. 8, light generating equipment 812 further includes a pump modulator 856, and processing circuitry 804 further includes a lock-in amplifier 866.

In operation, first laser generator 822 produces (pulsed) laser beam 801 (which is pulsed), and second laser generator 824 produces probe beam 815 (which is continuous-wave). According to some embodiments, and as depicted in FIG. 8, laser beam 801 is amplitude-modulated by pump modulator 856, thereby producing a (pulsed) pump beam 805. According to some embodiments, and as depicted in FIG. 8, prior to impinging on structure 82, pump beam 805 may be focused by objective lens 842 (optionally, after passage via first beam splitter 846). Similarly, according to some embodiments, and as depicted in FIG. 8, prior to impinging on structure 82, probe beam 815 may be focused by objective lens 842 (optionally, after passage via second beam splitter 848 and reflection by first beam splitter 846).

A first returned beam 825 (indicated by dotted lines) corresponds to a portion of probe beam 815, which is reflected off structure 82. According to some embodiments, and as depicted in FIG. 8, first returned beam 825 travels onto optical filter 852 (optionally, after reflection by first beam splitter 846 and passage via second beam splitter 848). A second returned beam 835 (indicated by dashed-double dotted lines) may correspond to a portion of pump beam 805, which is returned (reflected and/or scattered) from structure 82. According to some embodiments, and as depicted in FIG. 8, second returned beam 835 travels onto optical filter 852 (optionally, after reflection by first beam splitter 846 and passage via second beam splitter 848). A filtered beam 845 corresponds to the output of optical filter 852.

Light sensing assembly 814 is configured to measure one or more optical parameters of filtered beam 845, thereby obtaining one or more measured signals. According to some embodiments, wherein light sensing assembly 814 is or incorporates a fast optical detector, light sensing assembly 814 is configured to measure the instantaneous intensity of filtered beam 845, thereby allowing to obtain the time dependence of the intensity of filtered beam 845. According to some embodiments, wherein light sensing assembly 814 is or incorporates an ultra-high-resolution spectrometer, light sensing assembly 814 is configured to measure the spectrum of filtered beam 845, thereby allowing to directly detect the resonant frequencies. Processing circuitry 804 is configured to process the one or more measured signals to obtain therefrom one or more structural parameters, which characterize structure 82, as described above in the description of operation 140 of method 100, in the description of processing circuitry 604 of system 600, processing circuitry 704 of system 700, as described below in the description of FIGS. 9A and 11, and as elaborated on next.

More specifically, in embodiments including the fast optical detector, pump modulator 856, and lock-in amplifier 866, lock-in amplifier 866 may be configured to use the modulation frequency (employed by pump modulator 856 to modulate laser beam 801) to demodulate the measured signal (obtained by the fast optical detector) and thereby isolate a contribution thereto due to the induced vibrations of structure 82. From the demodulated signal, following application thereto of a Fourier transform algorithm (e.g., a fast Fourier transform), the induced resonant frequencies may be identified—e.g., by a processor(s) 868 included in processing circuitry 804—as described above in the description of method 100.

While in FIG. 8, the pump beam is shown as passing through a single beam splitter (i.e., first beam splitter 846) in travelling onto sample 80, and the probe beam is shown as passing through a pair of beam splitters (i.e., second beam splitter 848 and first beam splitter) in travelling onto sample 80, the skilled person will readily perceive that this arrangement is arbitrary and may be “inverted”. That is, according to some embodiments (not depicted in FIG. 8), the pump beam may be made to pass through a pair of beam splitters in travelling onto sample 80, and the probe beam may be made to pass through a single peam splitter in travelling onto sample 80.

FIG. 9A schematically depicts a computerized system 900, which corresponds to specific embodiments of system 600. System 900 includes an optical setup 902 and a processing circuitry 904, which correspond to specific embodiments of optical setup 602 and processing circuitry 604, respectively. Also depicted is a sample 90 including a (profiled) structure 92, which is being profiled by system 900. Sample 90 and structure 92 correspond to specific embodiments of sample 60 and structure 62, respectively. It is to be understood that sample 90 and structure 92 are not included in system 900. Optical setup 902 includes light generating equipment 912, a light sensing assembly 914, and a controller 918, which correspond to specific embodiments of light generating equipment 612, light sensing assembly 614, and controller 618, respectively. Light sensing assembly 914 includes one or more light sensors and/or a light sensor array. Also depicted is a stage 920 (e.g., a xyz stage) on which sample 90 is placed, which may be similar to stage 720.

Light generating equipment 912 may include a laser generator 922, configured to produce a pulsed laser beam including a plurality of laser pulses, a variable delay-line 958, and a (first) beam splitter 962. Variable delay-line 958 is configured to delay by a controllably selectable time delay (i.e., time interval) a laser pulse (and, more generally, a train of laser pulses) transmitted thereinto. According to some embodiments, and as depicted in FIG. 9A, variable delay-line 958 is positioned in the probe beam arm of light generating equipment 912, specifically between first beam splitter 962 and a third beam splitter 948, which may be similar to second beam splitter 748. According to some alternative embodiments, not depicted in FIG. 9A, the variable delay-line may be positioned in the pump beam arm of the light generating equipment 912, specifically between first beam splitter 962 and a second beam splitter 946, which may be similar to first beam splitter 746.

According to some embodiments, the one or more light sensors of light sensing assembly 914 include a fast optical detector.

According to some embodiments, and as depicted in FIG. 9A, light generating equipment 912 may further include a pump modulator 956, and processing circuitry 904 may include, in addition to a processor(s) 968, a lock-in amplifier 966. According to some embodiments, and as elaborated on below, pump modulator 956 may be configured to amplitude-modulate a pump beam transmitted thereinto, so as to facilitate isolating a contribution to the measured signal of a reflected portion of a probe beam projected on structure 92.

According to some embodiments, and as depicted in FIG. 9A, light generating equipment 912 may further include an objective lens 942, which may be similar to objective lens 742. According to some embodiments, and as depicted in FIG. 9A, optical setup 902 may further include an optical filter 952, which may be similar to optical filter 752.

In operation, laser generator 922 produces a laser beam including a plurality (i.e., a series) of laser pulses. To facilitate the description, the operation of optical setup 902 is described with respect to a single one of the laser pulses: an n-th laser pulse 901n in a laser beam produced by laser generator 922. According to some embodiments, a plurality of consecutive pump pulses may be generated within a respective timeframe of a size 1/B, wherein B is the bandwidth of light sensing assembly 914 (so that 1/B is the temporal resolution thereof). Accordingly, the rate of the probe pulses (which is substantially equal to that of the pump pulses) will be greater than the bandwidth of light sensing assembly 914, so that each measured intensity value will include contributions from the returned portions of each of a respective plurality of consecutively projected probe pulses within the timeframe 1/B.

n-th laser pulse 901n is split by first beam splitter 962 into two portions: a first (n-th) pulse portion 903n1 and a second (n-th) pulse portion 903n2. First pulse portion 903n1 is transmitted into pump modulator 956, and is amplitude-modulated thereby, so as to produce an n-th pump pulse 905n. Second pulse portion 903n2 is transmitted into variable delay-line 958, is delayed thereby by a respective time interval Δt′, thereby producing n-th probe pulse 915n. A modulation frequency, employed by pump modulator 956 to modulate the first pulse portions, is relayed (e.g., by controller 918) to lock-in amplifier 966.

Each of n-th pump pulse 905n and n-th probe pulse 915n are directed onto structure 92, so as to be incident thereon with n-th probe pulse 915n impinging on structure 92 at a delay, equal to the time interval Δt′, relative to n-th pump pulse 905n. According to some embodiments, variable delay-line 958 may be configured to continuously vary (e.g., increase) the path length travelled therethrough by a laser pulse, e.g., by continuously translating a movable component thereof (e.g., a mirror, a stage having a mirror arrangement mounted thereon). As a non-limiting example, according to some such embodiments, for any 1≤k≤N, wherein Nis the number of pump pulses in the pump beam, Δtₖ=(k−1)·Δt+ΔT (So that n-th probe pulse 915n is delayed by Δtₙ=(n−1)·Δt+ΔT relative to n-th pump pulse 905n.) ΔT>0 is the minimum time delay (i.e., Δt₁=min{Δtₖ}ₖ₌₁^{N}=ΔT). Δt=Δl/c, wherein c is the speed of light and Δl is the amount by which the path length increases between consecutively generated laser pulses. In particular, Δt may be selected such that Δt<<K/B (B is the bandwidth of light sensing assembly 914) or, equivalently, Δl<<cK/B, wherein K is a positive integer, which, according to some embodiments, is strictly greater than one. Further, Δt may selected to be small in comparison to the characteristic lifetime of the excited resonances, which, in turn, may be small in comparison with 1/B. Accordingly, K consecutively generated laser pulses may be considered as striking structure 92 at substantially the same time delay.

Alternatively, according to some embodiments, variable delay-line 958 may be configured to vary the path length in increments. According to some such embodiments, multiple probe pulses may be delayed at exactly a same time delay.

According to some embodiments, and as depicted in FIG. 9A, prior to impinging on structure 92, n-th pump pulse 905n may be focused by objective lens 942 (optionally, after passage via second beam splitter 946). Similarly, according to some embodiments, and as depicted in FIG. 9A, prior to impinging on structure 92, n-th probe pulse 915n may be focused by objective lens 942 (optionally, after passage via third beam splitter 948 and reflection by second beam splitter 946).

A first returned n-th pulse 925n (indicated by dotted lines) corresponds to a portion of n-th probe pulse 915n, which is reflected off structure 92. According to some embodiments, and as depicted in FIG. 9A, first returned n-th pulse 925n travels onto optical filter 952 (optionally, after reflection by second beam splitter 946 and passage via third beam splitter 948). A second returned n-th pulse 935n (indicated by dashed-double dotted lines) may correspond to a portion of n-th pump pulse 905n, which is returned (reflected and/or scattered) from structure 92. According to some embodiments, and as depicted in FIG. 9A, second returned n-th pulse 935n travels onto optical filter 952 (optionally, after reflection by second beam splitter 946 and passage via third beam splitter 948).

An n-th filtered pulse 945n corresponds to the output of optical filter 952. From optical filter 952 n-th filtered pulse 945n travels onto light sensing assembly 914. In embodiments wherein, as described above, K laser pulses are consecutively projected within the timeframe 1/B, light sensing assembly 914 does not distinguish between K consecutively filtered pulses, and accordingly measures the combined intensity of the K filtered pulses. Thus, light sensing assembly measures n-th filtered pulse 945n together with K−1 other filtered pulses to obtain a respective intensity value. The measured intensity values make up the measured signal. Alternatively, according to some embodiments, wherein each timeframe 1/B only a single laser pulse is generated, light sensing assembly 914 measures the intensity of n-th filtered pulse 945n to obtain an n-th intensity value.

The measured intensity values (i.e., the measured signal) are sent to lock-in amplifier 966. Lock-in amplifier 966 uses the modulation frequency (used to amplitude-modulate the pump beam) to obtain a demodulated signal (i.e., the measured signal after demodulation) in which the contribution to the reflected portion of the probe beam due to the induced vibrations is amplified, and contributions due background signals and/or noise may be suppressed.

The demodulated signal is relayed to processing circuitry 904. Processing circuitry 904 is configured to process the demodulated signal to determine one or more structural parameters, which characterize structure 92, as described above in the description of operation 140 of method 100, in the description of processing circuitry 604 of system 600, and below in the description of FIG. 12.

A j-th probe pulse, delayed at a j-th time interval Δtⱼ relative to the j-th pump pulse, may impinge on structure 92 when a j-th set of phases {φₘ^{(j)}}ₘ₌₁^{M} is realized (M is the number of resonant vibration modes excited by the pump pulses). A k-th (k j) probe pulse, delayed at a k-th time interval Δtₖ relative to the k-th pump pulse, may impinge on structure 92 when a k-th set of phases {φₘ^{(k)}}ₘ₌₁^{M}≠{φₘ^{(j)}}ₘ₌₁^{M} is realized. Accordingly, the reflected portion of the j-th probe pulse may be differently modulated than the reflected portion of the k-th probe pulse, so that from each of the reflected portions different information regarding the geometry and/or material composition of structure 92 may potentially be derived. The number of (distinct) time intervals N may be selected so as to maximize, or substantially maximize, the information derivable from the measured intensity values.

According to some embodiments, light generating equipment 912 may further include a harmonic generation unit (not shown) positioned between first beam splitter 962 and pump modulator 956. The harmonic generation unit is configured to receive as an input a laser beam directed from first beam splitter 962, generate one or more higher harmonics relative to a fundamental wavelength (i.e., the wavelength of the laser beam), which are selectable, beam, essentially as described below in the description of FIG. 9B. According to some such embodiments, the harmonic generation unit may be used in conjunction with an optical filter, which may be configured to filter out the fundamental wavelength and/or any other of the higher harmonics.

In FIG. 9A the pump beam arm is shown as not including a beam splitter (discounting the beam splitters positioned at the beginning and the end of the pump beam arm, i.e., first beam splitter 962 and second beam splitter 946, respectively). The probe beam arm is shown as including a single beam splitter, that is, third beam splitter 948 (discounting the beam splitters positioned at the beginning and the end of the probe beam arm, i.e., first beam splitter 962 and second beam splitter 946, respectively). The skilled person will readily perceive that this arrangement is arbitrary and may be “inverted”. That is, according to some embodiments (not depicted in FIG. 9), the pump beam arm includes a single beam splitter (discounting the beam splitters positioned at the beginning and the end of the pump beam arm) and the probe beam arm does not include a beam splitter (discounting the beam splitters positioned at the beginning and the end of the probe beam arm).

FIG. 9B schematically depicts light generating equipment 912′, which corresponds to specific embodiments of light generating equipment 612 of system 600. Light generating equipment 912′ is similar to light generating equipment 912 but differs therefrom in being configured to (i) allow projecting probe pulses characterized by a different wavelength as compared to the pump pulses, as well as (ii) allow projecting on a profiled structure a plurality (as a non-limiting example, two in FIG. 9B) of pump beams and a plurality (as a non-limiting example, two in FIG. 9B) of probe beams.

Light generating equipment 912′ may include a laser generator 922′, a pump modulator 956′, a variable delay-line 958′, and a (first) beam splitter 962′, which correspond to specific embodiments of laser generator 922, pump modulator 956, variable delay-line 958, and first beam splitter 962, respectively. According to some embodiments, and as depicted in FIG. 9B, light generating equipment 912′ may further include an objective lens 942′, a second beam splitter 946′, and a third beam splitter 948′, which may correspond to specific embodiments of objective lens 942, second beam splitter 946, and third beam splitter 948, respectively.

According to some embodiments, and as depicted in FIG. 9B, light generating equipment 912′ may further include a first harmonic generation unit 972′ and/or a second harmonic generation unit 974′. First harmonic generation unit 972′ may be positioned between first beam splitter 962′ and pump modulator 956′. Second harmonic generation unit 974′ may be positioned between first beam splitter 962′ and variable delay line 958′. The inclusion of first harmonic generation unit 972′ allows changing the wavelength of the pump beam (i.e., of each of the pump pulses) relative to that of the probe beam (i.e., of each of the probe pulses). For example, using first harmonic generation unit 972′, the pump beam may be prepared at the wavelength e.g., of the second harmonic or the third harmonic relative to a fundamental wavelength—i.e., the wavelength of the laser beam generated by laser generator 922′. To this end, according to some embodiments, light generating equipment 912′ may further include an optical filter (not shown) positioned between first harmonic generation unit 972′ and optical modulator 956′. The optical filter may be configured to allow selectively filtering therethrough light at one or more of the higher harmonics to the fundamental wavelength. In particular, in embodiments wherein the pump beam is prepared at one or more of the higher harmonics and the probe beam is prepared at the fundamental wavelength, the optical filter may be configured to selectively filter therethrough light at the one or more higher harmonics.

Similarly, the inclusion of second harmonic generation unit 974′ allows changing the wavelength of the probe beam relative to that of the pump beam. For example, using second harmonic generation unit 974′, the probe beam may be prepared at the wavelength e.g., of the second harmonic or the third harmonic relative to a fundamental wavelength. To this end, according to some embodiments, light generating equipment 912′ may further include an optical filter (not shown) positioned between second harmonic generation unit 974′ and third beam splitter 948′. The optical filter may be configured to allow selectively filtering therethrough light at one or more of the harmonics, e.g., at one or more of the higher harmonics to the fundamental wavelength.

Further, the inclusion of first harmonic generation unit 972′ allows projecting on structure 92′ a pump beam including two or more laser beams at two or more distinct wavelengths (e.g., the fundamental wavelength and the second harmonic, or the third harmonic and the fourth harmonic).

Similarly, the inclusion of second harmonic generation unit 974′ allows projecting on structure 92′ a probe beam including two or more laser beams at two or more distinct wavelengths (e.g., the fundamental wavelength and the second harmonic, or the third harmonic and the fourth harmonic).

According to some embodiments, not depicted in FIG. 9B, light generating equipment 912 may further include one or more prism elements and/or one or more diffraction gratings (not shown) positioned between pump modulator 956′ and second beam splitter 946′. These one or more prism elements and/or one or more diffraction gratings may be configured to allow manipulating the trajectories of pump beams, which differ from one another in wavelength, so as to allow impinging different pump beams (i.e., differing in wavelength) at different incidence angles, respectively, and/or at different locations, respectively, on structure 92′.

According to some embodiments, using first harmonic generation unit 972′, one or more prism elements, one or more diffraction gratings, and/or an acousto-optic modulator, a plurality of pump beams may be projected on structure 92′, so as to form thereon an illumination pattern, as described above in the description of FIG. 6. For example, according to some embodiments, the illumination pattern may be selected to substantially match the spatial and temporal profile of an excited resonant surface acoustic mode (such as the surface acoustic mode depicted in FIG. 5D), as described above in the description of FIG. 6. To this end, light generating equipment 612 may be configured to produce two pump beams, which slightly differ in wavelength and/or in the angle of incidence thereof.

According to some embodiments, not depicted in FIG. 9B, light generating equipment 912 may further include one or more prism elements, one or more diffraction gratings, and/or an acousto-optic modulator (not shown) positioned in the probe-beam arm of light generating equipment 912′ (e.g., between variable delay line 958′ and third beam splitter 948′). These one or more prism elements, the one or more diffraction gratings, and/or acousto-optic modulator may be configured to allow manipulating the trajectories of probe beams, which differ from one another in wavelength, so as to allow impinging different probe beams (i.e., differing in wavelength) at different incidence angles, respectively, and/or at different locations, respectively, on structure 92′.

In operation, laser generator 922′ produces a laser beam including a plurality (i.e., a series) of laser pulses. To facilitate the description, the operation of optical setup 902′ is described with respect to a single one of the laser pulses: an n-th laser pulse 901n′ in a laser beam produced by laser generator 922′. n-th laser pulse 901n′ is split by first beam splitter 962′ into two portions: a first (n-th) pulse portion 901n1′ and a second (n-th) pulse portion 901n2′. According to some embodiments, and as depicted in FIG. 9B, first pulse portion 901n1′ is transmitted into first harmonic generation unit 972′, thereby producing a third pulse portion 903n′. Third pulse portion 903n′ is transmitted into pump modulator 956′, and is amplitude-modulated thereby, so as to produce an n-th pump pulse 905n′. According to some embodiments, and as depicted in FIG. 9B, second pulse portion 901n2′ is transmitted into second harmonic generation unit 974′ producing a fourth pulse portion 913n′. Fourth pulse portion 913n′ is transmitted into variable delay-line 958′, is delayed thereby by a respective time interval Δt′, thereby producing n-th probe pulse 915n′. A modulation frequency, employed by pump modulator 956′ to modulate the first pulse portions, is relayed to a lock-in amplifier (not shown in FIG. 9B), such as lock-in amplifier 966.

Each of n-th pump pulse 905n′ and n-th probe pulse 915n′ are directed onto structure 92′, so as to be incident thereon with n-th probe pulse 915n′ impinging on structure 92′ at a delay, equal to the time interval Δt′, relative to n-th pump pulse 905n′. According to some embodiments, variable delay-line 958′ may be configured to continuously vary (e.g., increase) the path length travelled by a laser pulse therethrough, e.g., by continuously translating a movable component thereof, as described above in the description of FIG. 9B.

According to some embodiments, and as depicted in FIG. 9B, prior to impinging on structure 92′, n-th pump pulse 905n′ may be focused by objective lens 942′ (optionally, after passage via second beam splitter 946′). Similarly, according to some embodiments, and as depicted in FIG. 9A, prior to impinging on structure 92′, n-th probe pulse 915n′ may be focused by objective lens 942′ (optionally, after passage via third beam splitter 948′ and reflection by second beam splitter 946′).

A first returned n-th pulse 925n′ (indicated by dotted lines) corresponds to a portion of n-th probe pulse 915n′, which is reflected off structure 92′. According to some embodiments, and as depicted in FIG. 9B, first returned n-th pulse 925n′ travels onto an optical filter 952′ (optionally, after reflection by second beam splitter 946′ and passage via third beam splitter 948′). A second returned n-th pulse 935n′ (indicated by dashed-double dotted lines) may correspond to a portion of n-th pump pulse 905n′, which is returned (reflected and/or scattered) from structure 92′. According to some embodiments, and as depicted in FIG. 9B, second returned n-th pulse 935n′ travels onto optical filter 952′ (optionally, after reflection by second beam splitter 946′ and passage via third beam splitter 948′).

An n-th filtered pulse (not shown) corresponds to the output of optical filter 952′ (not shown). From the optical filter the n-th filtered pulse travels onto a light sensing assembly (not shown), such as light sensing assembly 914, whereat the n-th filtered pulse is sensed. According to some embodiments, the n-th filtered pulse is sensed in a non-discriminant manner from other filtered pulses corresponding to a plurality of laser pulses (including n-th laser pulse 901n′), which are consecutively generated within a timeframe 1/B. B is the bandwidth of a light sensor (e.g., fast optical detector) of the light sensing assembly.

The measured intensity values (i.e., the measured signal) are sent to the lock-in amplifier, which uses the modulation frequency to obtain a demodulated signal in which the contribution to the reflected portion of the probe beam due to the induced vibrations is amplified, and contributions due background signals and/or noise may be suppressed.

The demodulated signal is relayed to a processing circuitry (not shown), which may be similar to processing circuitry 904. The processing circuitry is configured to process the demodulated signal to determine one or more structural parameters, which characterize structure 92′, as described above in the description of operation 140 of method 100, in the description of processing circuitry 604 of system 600, and below in the description of FIG. 12.

FIG. 10 presents a flowchart of a method 1000 for metrology of structures (e.g., semiconductor structures on and/or in patterned wafers), which corresponds to specific embodiments of method 100, wherein each of the pump beam(s) and the probe beam(s) is continuous-wave. Method 1000 includes:
An operation 1010, wherein an amplitude-modulated pump beam (e.g., pump beam 705), whose modulation frequency is swept (i.e., continuously varied across one or more frequency ranges), is projected on a structure to be profiled (“the profiled structure”). The pump beam is configured to be absorbed by the profiled structure, thereby inducing vibrations of the profiled structure and a corresponding change in the reflection coefficient of the profiled structure.
An operation 1020, implemented while the profiled structure is vibrating, wherein a (continuous-wave) probe beam (e.g., probe beam 715) is projected on the profiled structure.
An operation 1030, wherein a measured signal is obtained by sensing a light beam (e.g., including first returned beam 725 or including filtered beam 745) returned from the profiled structure.
An operation 1040, wherein the measured signal is processed to determine (values of) one or more structural parameters of the profiled structure.

Operations 1010, 1020, 1030, and 1040 correspond to specific embodiments of operations 110, 120, 130, and 140, respectively, of method 100.

Method 1000 may be implemented using system 700 or a system similar thereto. More specifically, operations 1010 and 1020 may be implemented using light generating equipment, such as light generating equipment 712. The pump and probe beam may be produced using laser generators, such as first laser generator 722 and second laser generator 724, respectively.

According to some embodiments, the (amplitude) modulation frequency of the pump beam is swept over a plurality of frequency windows. The respective frequency range (i.e., size and location) over which a frequency window extends may be selected to include a respective resonant frequency corresponding to a specific resonant vibration mode, as explained above in the description of method 100, according to some embodiments thereof. The number of frequency windows may be selected to maximize throughput. Thus, a single frequency window may be dedicated to two resonant vibration modes whose frequencies are sufficiently close.

According to some embodiments, the pump beam may be doubly amplitude-modulated, as described above in the description of method 100 and in the description of system 700. The second amplitude-modulation is intended to facilitate isolating a contribution to the measured signal of a transient component of the reflected portion of the probe beam.

FIG. 11 presents a flowchart of a method 1100 for metrology of structures (e.g., semiconductor structures on and/or in patterned wafers), which corresponds to specific embodiments of method 100, wherein the pump beam(s) is pulsed and the probe beam(s) is continuous-wave. Method 1100 includes:
An operation 1110, wherein a pulsed pump beam (e.g., pump beam 805, according to some embodiments thereof), i.e., a pump beam including a plurality of consecutively generated pump pulses is projected on a structure, which is to be profiled. Each of the pump pulses is configured to be absorbed by the profiled structure, thereby inducing vibrations of the profiled structure and a corresponding change in the reflection coefficient of the profiled structure.
An operation 1120, at least partially overlapping with operation 1110, wherein a (continuous-wave) probe beam (e.g., probe beam 815 according to some embodiments thereof) is projected on the profiled structure.
An operation 1130, wherein a measured signal is obtained by sensing a light beam (e.g., including first returned beam 825 or including filtered beam 845) returned from the profiled structure.
An operation 1140, wherein the measured signal is processed to determine (values of) one or more structural parameters of the profiled structure.

Operations 1110, 1120, 1130, and 1140 correspond to specific embodiments of operations 110, 120, 130, and 140, respectively, of method 100.

Method 1100 may be implemented using system 800 or a system similar thereto. More specifically, operations 1110 and 1120 may be implemented using light generating equipment, such as light generating equipment 812. The pump beam and the probe beam may be produced using laser generators, such as first laser generator 822 and second laser generator 824, respectively.

According to some embodiments, the pump beam may be amplitude-modulated to facilitate isolating a contribution to the measured signal of a transient component of the reflected portion of the probe beam, as described above in the description of method 100 and in the description of system 800.

FIG. 12 presents a flowchart of a method 1200 for metrology of structures, which corresponds to specific embodiments of method 100, wherein each of the pump beam(s) and probe beam(s) is pulsed, including short-duration light pulses. Method 1200 includes:
An operation 1210, wherein a pulsed pump beam is projected on a structure, which is to be profiled. Each of the pump pulses is configured to be absorbed by the profiled structure, thereby inducing vibrations of the profiled structure and a corresponding change in the reflection coefficient of the profiled structure.
An operation 1220, wherein, simultaneously to the projection of the probe beam, a pulsed probe beam, i.e., a probe beam including a plurality of consecutively generated probe pulses is projected on the profiled structure. For each 1≤n≤N−1 (N being the number of probe pulses), the n-th probe pulse (e.g., n-th probe pulse 915n) may succeed the n-th pump pulse (e.g., n-th pump pulse 905n) and the precede the (n+1)-th pump pulse. The time delay between at least some succeeding pump-probe pulse pair is varied.
An operation 1230, wherein a measured signal is obtained by sensing light (e.g., including light pulses such as first returned n-th pulse 925n or including filtered light pulses such as n-th filtered pulse 945n) returned from the profiled structure as a result of the of impinging thereon of the pulsed probe beam.
An operation 1240, wherein the measured signal is processed to determine (values of) one or more structural parameters of the profiled structure.

Operations 1210, 1220, 1230, and 1240 correspond to specific embodiments of the set of operations including operations 110, 120, 130, and 140 of method 100.

Method 1200 may be implemented using system 900 or a system similar thereto. More specifically, operations 1210 and 1220 may be implemented using light generating equipment, such as light generating equipment 912.

According to some embodiments, for any 1≤n≤N: Δtₙ=(n−1)·Δt+ΔT, wherein Δt>0 and ΔT>0. Thus, in the first implementation of suboperation 1220 Δt₁=ΔT, in the second implementation thereof Δt₂=Δt+ΔT, in the third implementation thereof 1220 Δt₃=2Δt+ΔT, and so on.

According to some embodiments, the pump beam may be amplitude-modulated to facilitate removing noise and/or background signals from the measured signal, as described above in the description of system 900.

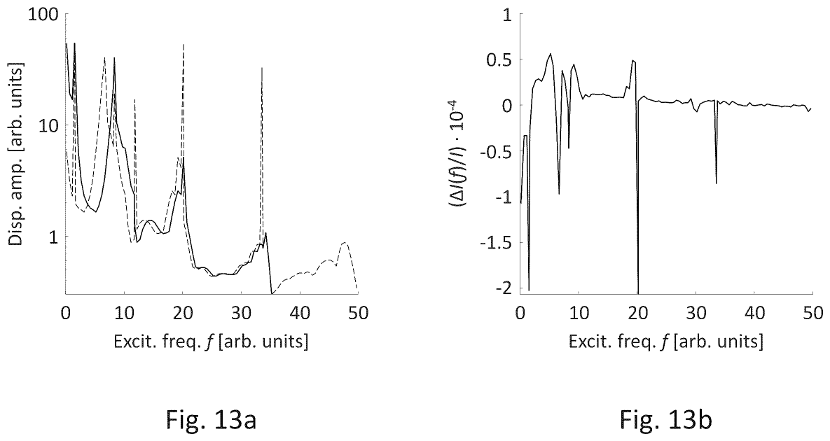

FIGS. 13A and 13B present results of computer simulations, which indicate the feasibility of the disclosed methods. Projection of a pump beam and resulting vibrations of a FinFET-like shaped structure, such as structure 22, were simulated. Referring to FIG. 13A, plotted by a solid line is the displacement amplitude of lateral (in parallel to the y-axis per the choice of coordinate system of FIG. 2) vibrations of the structure as a function of the excitation modulation frequency (i.e., the modulation frequency of the pump beam). Plotted by a dashed line is the (simulated) displacement amplitude of vertical (in parallel to the z-axis per the choice of coordinate system of FIG. 2) vibrations of the structure as a function of the excitation modulation frequency. The two plots exhibit sharp peaks corresponding to resonance excitations (i.e., at the resonant frequencies the displacement amplitude of the vibrations is markedly amplified).

Referring to FIG. 13B, plotted is the relative change in the reflection coefficient of the structure as a function of the excitation modulation frequency ƒ More specifically, plotted is ΔR(ƒ)/R. The plot exhibits sharp dips corresponding to excited resonant modes.

As used herein, according to some embodiments, the term “beam” with reference to a light beam, such as a laser beam, may refer to a continuous-wave light beam or a pulsed light beam (a train of light pulses).

As used herein, according to some embodiments, the terms “vibration modes” and “vibrations patterns” are used interchangeably. In particular, the terms “resonant vibration modes” and “resonant vibration patterns” are used interchangeably.

In the description and claims of the application, the words “include” and “have”, and forms thereof, are not limited to members in a list with which the words may be associated.

As used herein, the term “substantially” may be used to specify that a first property, quantity, or parameter is close or equal to a second or a target property, quantity, or parameter. For example, a first object and a second object may be said to be of “substantially the same length”, when a length of the first object measures at least 80% (or some other pre-defined threshold percentage) and no more than 120% (or some other pre-defined threshold percentage) of a length of the second object. In particular, the case wherein the first object is of the same length as the second object is also encompassed by the statement that the first object and the second object are of “substantially the same length”.

According to some embodiments, the target quantity may refer to an optimal parameter, which may in principle be obtainable using mathematical optimization software. Accordingly, for example, a value assumed by a parameter may be said to be “substantially equal” to the maximum possible value assumable by the parameter, when the value of the parameter is equal to at least 80% (or some other pre-defined threshold percentage) of the maximum possible value. In particular, the case wherein the value of the parameter is equal to the maximum possible value is also encompassed by the statement that the value assumed by the parameter is “substantially equal” to the maximum possible value assumable by the parameter.

As used herein, the term “about” may be used to specify a value of a quantity or parameter (e.g., the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

For ease of description, in some of the figures a three-dimensional cartesian coordinate system (with orthogonal axes x, y, and z) is introduced. It is noted that the orientation of the coordinate system relative to a depicted object may vary from one figure to another. Further, the symbol ⊙ may be used to represent an axis pointing “out of the page”, while the symbol ⊗ may be used to represent an axis pointing “into the page”.

Referring to the figures, in block diagrams and flowcharts, optional elements and operations, respectively, may appear within boxes delineated by a dashed line.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although operations in disclosed methods, according to some embodiments, may be described in a specific sequence, methods of the disclosure may include some or all of the described operations carried out in a different order. A method of the disclosure may include a few of the operations described or all of the operations described. No particular operation in a disclosed method is to be considered an essential operation of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purposes and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A computerized system for metrology of structures, the system comprising:
an optical setup configured to:
project on a profiled structure at least one pump beam, which is configured to be absorbed by the profiled structure, so as to induce vibrations throughout the profiled structure and thereby cause a corresponding change in a reflection coefficient of the profiled structure, wherein the at least one pump beam is configured such that the induced vibrations comprise one or more resonant vibrations corresponding to excited resonant modes;
while the profiled structure is vibrating, project on the profiled structure at least one probe beam; and
sense at least one light beam returned from the profiled structure, thereby obtaining at least one measured signal; and
processing circuitry configured to process the at least one measured signal to identify frequencies of each of the one or more resonant vibrations, and, based at least thereon, determine one or more structural parameters of the profiled structure.

2. The system of claim 1, wherein processing performed by the processing circuitry comprises searching for peaks and/or dips in each of the at least one measured signal, and/or in each of at least one processed signal derived therefrom, respectively, and, for each detected peak/dip, determining whether the peak/dip corresponds to a resonant vibration, and, if so, localizing the peak/dip and, optionally, determining the intensity of the peak/dip.

3. The system of claim 1, wherein the profiled structure is characterized by a geometry, which varies about periodically along one direction.

4. The system of claim 1, wherein the processing circuitry is configured to execute an algorithm, which has been trained to correlate between measured signals, or processed signals derived therefrom, and structural parameters obtained from ground truth data of structures of a same intended design as the profiled structure.

5. The system of claim 1, wherein the optical setup comprises light generating equipment and at least one light sensor;
wherein the light generating equipment is configured to generate the at least one pump beam and the at least one probe beam; and
wherein the at least one light sensor is configured to measure an intensity and/or a spectrum of the at least one returned light beam, respectively.

6. The system of claim 5, wherein the at least one light sensor comprises a fast optical detector.

7. The system of claim 1, wherein the light generating equipment further comprises an optical modulator, which is configured to amplitude-modulate the at least one pump beam;
wherein the processing circuitry comprises one or more processors and a lock-in amplifier;
wherein the lock-in amplifier is configured to use a modulation frequency of the at least one pump beam to demodulate the measured signal and extract a transient component thereof, and thereby isolate a contribution to the transient component of a reflected portion of the probe beam due to the induced vibrations; and
wherein the one or more processors are configured to process the isolated contribution to the transient component to determine one or more structural parameters of the profiled structure.

8. The system of claim 1, wherein each of the at least one pump beam is a laser beam and/or each of the at least one probe beam is a laser beam.

9. The system of claim 1, wherein the at least one pump beam comprises two or more pump beams configured to produce a static, a time-dependent, or a travelling illumination pattern on the profiled structure; and/or
wherein the at least one light sensor is configured to sense light returned from different locations on the profiled structure.

10. The system of claim 9, wherein the two or more pump beams are configured to excite one or more surface acoustic modes at resonance with the structure.

11. The system of claim 1, wherein each of the at least one pump beam is pulsed, comprising a plurality of consecutively generated pump pulses.

12. The system of claim 11, wherein a duration(s) of each of the pump pulses is shorter by at least about an order of magnitude than a duration of a relaxation interval of the induced vibrations.

13. The system of claim 5, wherein the light generating equipment comprises a continuous-wave (CW) laser generator configured to prepare the probe beam.

14. The system of claim 1, wherein the processing circuitry is configured to apply a Fourier transform algorithm to each of the at least one measured signal, and/or to each of an at least one initially processed signal obtained from the at least one measured signal, respectively.

15. The system of claim 13, wherein each of the at least one pump beam is pulsed, comprising a plurality of consecutively generated pump pulses, and wherein the at least one light sensor comprises an ultra-high-resolution spectrometer and/or a fast optical detector(s) having a bandwidth that is at least about twice greater than a maximum frequency of the induced resonant vibrations.

16. The system of claim 11, wherein each of the at least one probe beam is pulsed, comprising a plurality of consecutively generated probe pulses;
wherein a pulse rate of the probe pulses is equal to a pulse rate of the pump pulses; and
wherein the light generating equipment comprises a variable delay-line configured to allow controllably setting a time-delay of each of the probe pulses relative to the pump pulses, respectively.

17. The system of claim 13, wherein the light generating equipment comprises an additional CW laser generator, which is configured to prepare the at least one pump beam; and
wherein the light generating equipment is further configured to sweep an amplitude-modulation frequency of the at least one pump beam across one or more modulation frequency ranges.

18. The system of claim 17, wherein the optical setup further comprises a controller, wherein the additional CW laser generator includes two frequency-locked CW laser sources, and wherein the controller is configured to vary a frequency difference between the two frequency-locked CW laser sources, thereby implementing the frequency sweep.

19. The system of claim 1, wherein the profiled structure is constructed as part of a manufacturing processes of semiconductor devices and/or components of semiconductor devices; or
wherein the profiled structure is an assist structure, which is constructed as part of a manufacturing processes of semiconductor devices and/or components of semiconductor devices.

20. A method for metrology of structures, the method comprising operations of:
projecting on a profiled structure at least one pump beam, which is configured to be absorbed by the profiled structure, so as to induce vibrations throughout the profiled structure, which cause a corresponding change in a reflection coefficient of the profiled structure;
while the profiled structure is vibrating, projecting on the profiled structure at least one probe beam;
sensing at least one light beam returned from the profiled structure, thereby obtaining at least one measured signal; and
processing the at least one measured signal to determine one or more structural parameters of the profiled structure;
wherein the at least one pump beam is configured such that the induced vibrations comprise one or more resonant vibrations corresponding to excited resonant modes; and
wherein the operation of processing at least one measured signal comprises identifying frequencies of each of the one or more resonant vibrations, and, based at least thereon, determining the one or more structural parameters of the profiled structure.
